(19) United States
(12) Patent Application Publication
(10) Pub. No.: US 2006/0148557 A1
(43) Pub. Date: Jul. 6, 2006

(54) Gaming machine and gaming system

(75) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE Corp.

(21) Appl. No.: 11/295,705

(22) Filed: Dec. 7, 2005

(30) Foreign Application Priority Data
Dec. 10, 2004 (JP) 2004-358769

(51) Int. Cl. A63F 13/00

(52) U.S. Cl. 463/25

(57) ABSTRACT

There is provided a gaming machine or a gaming system which may provide a game player with an incentive to play a game repeatedly without lowering the player's anticipation for a shift to a special game mode. The gaming machine 1A comprises shift determination means for determining whether a base game mode is shifted to a special game mode based on a first shift condition unless a game article 90 storing game related information is removed. If the game related information can be read from the game article 90, shift determination to the special mode may be made under a second shift condition.

### CROSS REFERENCE TO RELATED APPLICATIONS

This application is based upon and claims the benefits of priorities from Japanese Patent Application No. 2004-358769 filed on Dec. 10, 2004, the entire contents of which are incorporated herein by reference. This application is also related to a co-pending U.S. patent application entitled “Gaming Machine And Gaming System Therefor” and filed on even date herewith and being assigned to the same assignee as the present application. The co-pending application including specification, drawings and claims are expressly incorporated herein by reference in its entirety.

### FIELD OF THE INVENTION

The present invention relates to a gaming machine and a gaming system in which a game can be conducted in a base game mode and a special game mode.

### RELATED ART

There has been conventionally available a gaming machine, which could also be referred to as “slot machine.” In the gaming machine, a plurality of symbols are variably displayed in a plurality of arrays, or images of the plurality of varyingly displayed symbols are displayed in the plurality of arrays. A combination of symbols in each array may be fixed when the varying display is stopped and is referred to determine whether the fixed combination of symbols matches a winning combination or not and how the winning combination is like (a winning mode). Then, the gaming machine pays out game media such as medals and coins to be used in a game (hereinafter referred to as “coin”) according to the obtained winning combination. In this type of gaming machine, the game is played not only in a base game mode where a base game can be played, but also in a special game mode where a bonus game, which provides more advantageous conditions to the player, can be played. Thus, the bonus game may provide some awards to the player when the specific condition that a predetermined combination of symbols appears in the arrays. For example, Japanese patent application publication No. 2002-537874 discloses a gaming machine having a plurality of bonus games from which a bonus game is randomly picked up by lottery.

There has also been available a gaming machine, for example, a home-use gaming machine, in which prior to starting a game, no coin insertion is necessary (or no game medium insertion) or no coins are paid out according to the winning combination. Among these types of gaming machines, there is a gaming machine which conducts a game with information being read from a figure storing game data. For example, Japanese patent application publication No. 2004-216038 discloses a gaming machine which conducts a game by using information being stored in a figure and being corresponding to a character appearing in the game wherein the figure is used in the gaming machine. Further, Japanese patent application publication No. 2002-325972 discloses a gaming machine which conducts a game by using information of a plurality of figures being set in reading positions thereof.

In the above-described gaming machine in which coins are paid out, the player usually plays the game paying an attention to a possible shift to a special game mode in which special conditions are provided such as an increased probability of payout and a larger number of coins to be paid out.

However, in the gaming machine described in Japanese patent application publication No. 2004-216038, a shift condition from a base game mode to a special game mode is determined in advance with the gaming machine and the game therefore may not have enough variation. Further, the player easily becomes bored after playing the game with limited variation over and over again and can easily figure out whether or not the game mode will be shifted to a special game mode. Thus, this type of gaming machine may have difficulty in providing the player with an enough incentive to play the game repeatedly and may lower the player's sense of anticipation of the shift to the special game mode. Therefore, it is desired to provide a new gaming machine with enough variation.

In the gaming machine (home-use gaming machine) described in Japanese patent application publication Nos. 2004-216038 and 2002-325972, a figure is used as a component other than the gaming machine. However, the figure is a so-called essential component in playing the game and does not provide the player with an incentive to play the game repeatedly. Further, in this type of gaming machine, no coins are paid out or no special game mode is available. Therefore, the player cannot have a sense of anticipation that the game mode will shift to the special game mode.

Under these circumstances, players have been desirous that a new gaming machine emerges, which can provide them with an incentive which would not be available by the conventional gaming machine without lowering their sense of anticipation that the game mode may shift to the special game mode so that they may not become bored after the game is played repeatedly.

### SUMMARY OF THE INVENTION

In the present invention, there is provided a gaming machine and a gaming system utilizing the gaming machine. The gaming machine performs a game including a base game mode and a special game mode and comprises: a display device for displaying game contents; and a reading device for reading game related information including identification information and play history information from a game article. In the game the base game mode can be shifted to the special game mode under a predetermined condition. And the predetermined condition comprises a first shift condition if it is determined that the reading device cannot read the game related information from the game article, whereas the predetermined condition comprises a second shift condition if it is determined that the reading device can read the game related information from the game article. The predetermined condition may comprise a contingent condition. And it is more likely that the base game mode is shifted to the special game mode under the second shift condition than under the first shift condition. The gaming machine may comprise an operation device for playing the game. The operation device may comprise an operation panel, a touch screen, a lever, a button, a remote control device, and the like.

Further features of the present invention, its nature, and various advantages will be more apparent from the accompanying drawings and the following description of the preferred embodiment.

### BRIEF DESCRIPTION OF THE DRAWINGS

FIG. 1 is a perspective view showing a general configuration of a slot machine according to an embodiment of a gaming machine of the present invention.

FIG. 2 is a front view of a main display of the slot machine shown in FIG. 1.

FIG. 3 is a perspective view showing the reel configuration.

FIG. 4 is a perspective view showing one of the reels shown in FIG. 3.

FIG. 5 is a perspective view showing a general configuration of the liquid crystal display device when viewed from a back side of a cabinet.

FIG. 6 is an exploded perspective view showing a part of the liquid crystal display unit.

FIG. 7 is a block diagram mainly showing an internal constitution of the slot machine of the embodiment 1.

FIG. 8 is a block diagram showing one example of the internal constitution of the image control circuit.

FIG. 9 is a partially broken front view of the figure.

FIG. 10 is a flow chart showing operational procedures from the start to the completion of the slot game.

FIG. 11 is a flow chart showing operational procedures for the figure information reading acceptance process.

FIG. 12 is a flow chart showing operational procedures for the figure-present game process.

FIG. 13 is a flow chart showing operational procedures for the figure-absent game process.

FIG. 14 is a drawing showing one example of the symbol determination table for a base condition.

FIG. 15 is a drawing showing one example of the symbol determination table for a special condition.

FIG. 16 is a drawing showing one example of the halt table.

FIG. 17 is a flow chart showing operational procedures for the figure-present game process related to the second operational example.

FIG. 18 is a drawing showing one example of the high probability shift condition table.

FIG. 19 is a timing chart showing one example of the change in game mode.

FIG. 20 is a timing chart showing another example of the change in game mode.

FIG. 21 is a perspective view showing a whole constitution of the slot machine which is the embodiment 2 of the gaming machine of the present invention.

FIG. 22 is a block diagram showing an internal constitution of the slot machine of the embodiment 2.

FIG. 23 is a block diagram showing a brief constitution of the gaming system of the present invention.

FIG. 24 is a flow chart showing operational procedures from the start to the completion of the slot game in the gaming system.

### DESCRIPTION OF THE PREFERRED EMBODIMENT

Hereinafter, an explanation will be made for a gaming machine of an embodiment according to the present invention. In the following description, like element numerals are used to describe like elements illustrated in one or more figures and duplicated explanation may be omitted.

A slot machine 1A according to the embodiment 1 of the present invention is provided with variable display means for variably displaying a plurality of symbols and so configured that the slot machine may perform a variable display game (also called a slot game) using a plurality of symbols displayed variably. The slot machine 1A may provide not only a base game mode in which a base game that is initiated when a predetermined number of coins or credits are inserted or used can be played, but also in a special game mode in which a bonus game that is initiated under a certain condition in the base game and played subsequently. The slot machine 1A is a coin-insertion type of gaming machine, and the variable display game conducted as a base game is initiated when a player inserts a coin or uses a credit. On the other hand, a variable display game (free game) conducted as a bonus game is a game in which a reel is automatically rotated without insertion of coins and stopped after a predetermined period of time. Then, the slot machine 1A pays out a predetermined number of coins depending on a combination of symbols being stopped and displayed. Thus, the bonus game has the contents more advantageous to the player than the base game does. Hereinafter, an explanation will be made for the configuration of the slot machine 1A.

(General Configuration of Slot Machine)

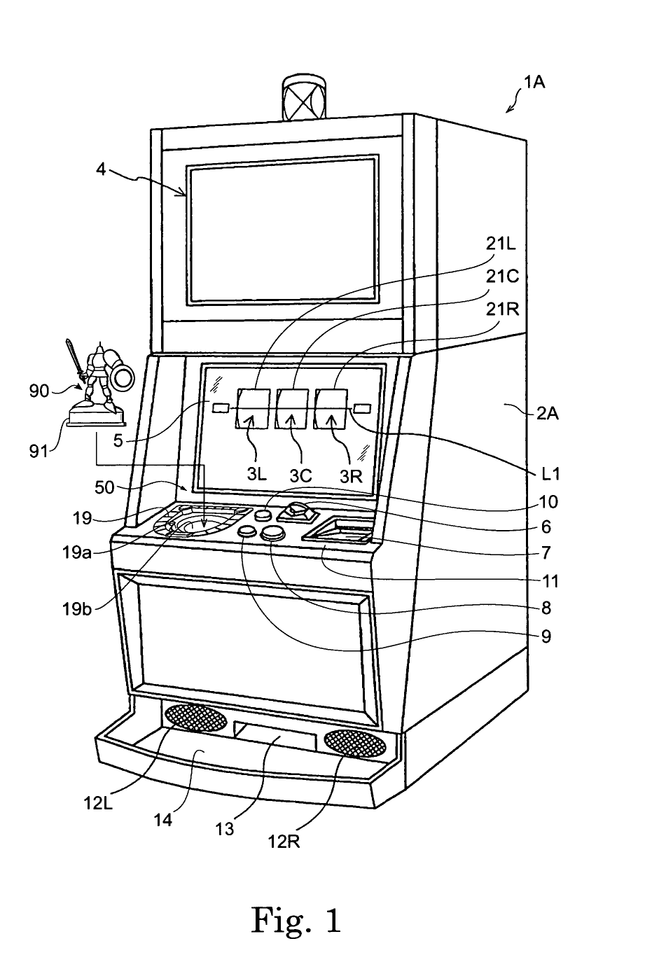

FIG. 1 is a perspective view showing a general configuration of the slot machine 1A. The slot machine 1A is provided with a sub display 4 and a main display 5 on the front face of the cabinet 2A in an order from the higher part. The main display 5 is disposed approximately at the middle of the height of the cabinet 2A and three mechanical reels, 3L, 3C and 3R, are arranged in a freely rotatable way along a single line from left to right inside the cabinet 2A so that they may appear from the main display 5.

These reels, 3L, 3C and 3R, are disposed so that they can be visually recognized from the outside through symbol display areas, 21L, 21C and 21R of the main display 5 to be explained later. The reels, 3L, 3C and 3R, which will be explained in detail later, are provided with an array of symbols (not illustrated) being composed of a plurality of types of symbols on each outer circumferential face. Freely-rotatable variable display means is constituted so that each symbol can be variably displayed and that each reel rotates at a fixed speed (for example, 80 rpm).

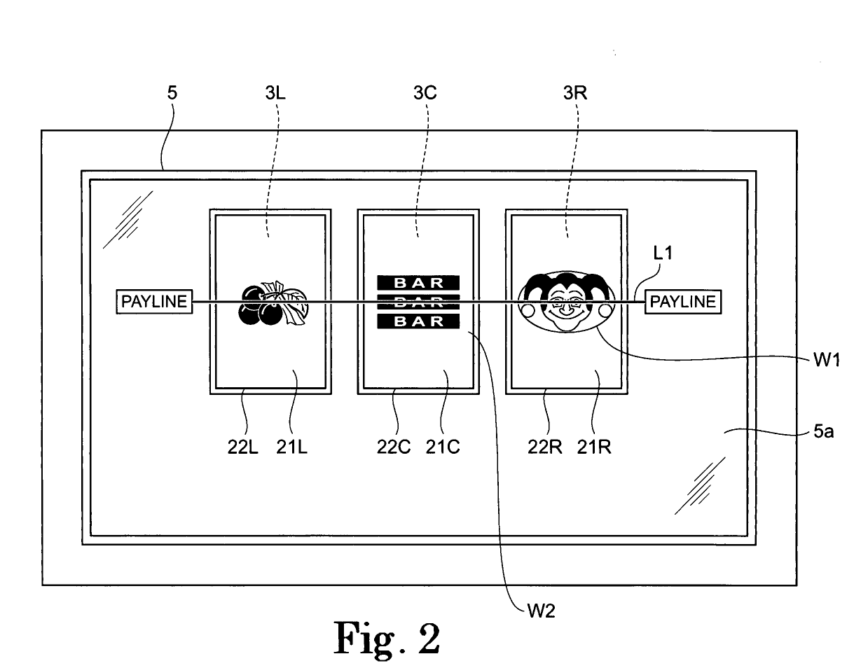

As shown in FIG. 2, in the symbol display areas, 21L, 21C and 21R, respectively corresponding to these reels, 3L, 3C and 3R, one winning line L1 extending horizontally is provided. Further, in addition to the winning line L1, other winning lines may be provided above and below the pay line L1 (not illustrated) or additional two winning lines may be provided in a diagonal way. When a plurality of winning lines are provided, it may be arranged that the number of the lines varies according to the number of coins inserted. In this instance, each winning line is to be activated according to the number of coins inserted and an operation of BET switches 9 and 10 to be explained later. The activated winning line is called an activated line or a pay line. For example, when a player inserts one coin into a coin insertion slot 6 to be explained later, only the center winning line L1 is activated, when inserting two coins, the winning lines above and below the center winning line L1 are activated in addition to the winning line L1, and when inserting three coins, all the winning lines are activated. Further, FIG. 2 shows a state that symbols are stopped only on the winning line L1 for better illustration. In most cases, however, three symbols are displayed vertically in each of the symbol display areas, 21L, 21C and 21R.

The slot machine 1A is also provided below the main display 5 with a substantially horizontal operation panel 11. The operation panel 11 is provided with a figure installation unit 19, a coin insertion slot 6, a bill insertion slot 7, a spin switch 8, a single BET switch 9 and a maximum BET switch 10.

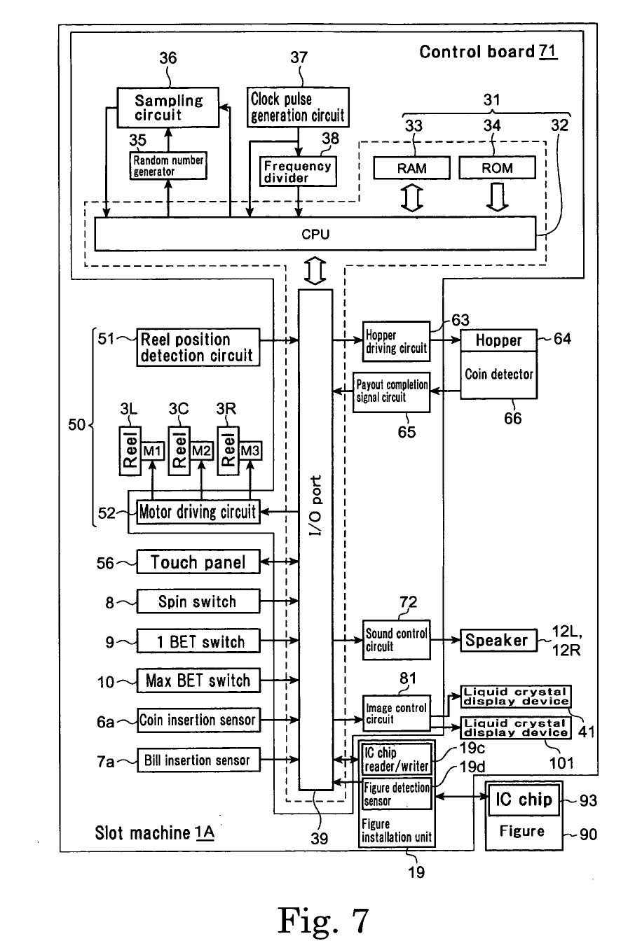

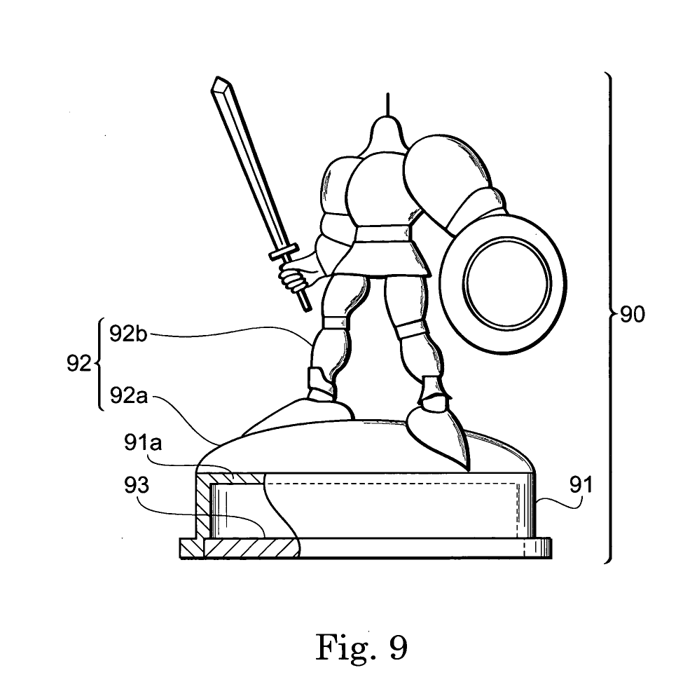

The figure installation unit 19 is provided with a base fitting portion 19a fixed on the operation panel 11 and a reading part (reader) 19b. The base fitting portion 19a is provided inside with a recess corresponding to a thick circular plate-like base portion 91 in a figure 90(refer to FIG. 9) to be explained later and designed in such a way that the base portion 91 can be fitted into the recess. The reading part 19b is disposed at the recess of the base fitting portion 19a and provided with an IC chip reader/writer 19c (refer to FIG. 7) and a figure detection sensor 19d (refer to FIG. 7). The IC chip reader/writer 19C and the figure detection sensor 19d are connected to a CPU 32 via an I/O port 39. The IC chip reader/writer 19C reads stored information (figure ID and others) from an IC chip 93 built in the base portion 91 of the figure 90, inputs the information to the CPU 32, and writes predetermined information into the IC chip 93 in accordance with instructions from the CPU 32. The IC chip reader/writer 19c is corresponding to (and included by) the reading means according to the present invention. Further, the figure detection sensor 19d (refer to FIG. 7) detects whether or not the figure 90 is placed (or installed) on the base fitting portion 19a (the figure is set or not) and inputs into the CPU 32 the detection information showing the detection result. The figure detection sensor 19d (refer to FIG. 7) may include various sensors such as a magnetic sensor and a mechanical sensor in addition to an optical sensor such as a transmission-type sensor, a reflection-type sensor and a pressure sensor. Further, the figure installation unit 19 is provided with an LED (not illustrated) and designed such that light is radiated from the LED to the figure 90 while the figure is being read, which will be explained later.

The coin insertion slot 6 is an insertion part of the present invention through which the player inserts coins to bet the coins on a game, and there is provided a coin insertion sensor 6a therein (refer to FIG. 7) wherein the coin insertion sensor 6a outputs a signal which shows insertion of coins. Further, the bill insertion slot 7 is provided in order for the player to insert a bill and there is also provided a bill insertion sensor 7a therein (refer to FIG. 7) which outputs a signal that shows insertion of bills. The spin switch 8 is provided in order for the player to start the variable display of symbols by rotating individual reels, 3L, 3C and 3R, wherein the symbols are displayed inside the symbol display areas, 21L, 21C and 21R. That is, the player operates the spin switch 8 to start the game. The single BET switch (1 BET switch) 9 is provided for the player to set a case where one coin is bet by a single operation. The maximum BET switch 10 is provided for the player to set a case where the maximum number of coins to be bet in one game are bet by a single operation.

Further, the slot machine 1A is provided at the bottom portion of the cabinet 2A with a coin payout opening 13 and a coin receiving part 14 for receiving paid-out coins. The coin payout opening 13 is equivalent to (and included by) the payout part of the present invention. Speakers, 12L and 12R, are provided both on the right and left sides of the payout opening 13.

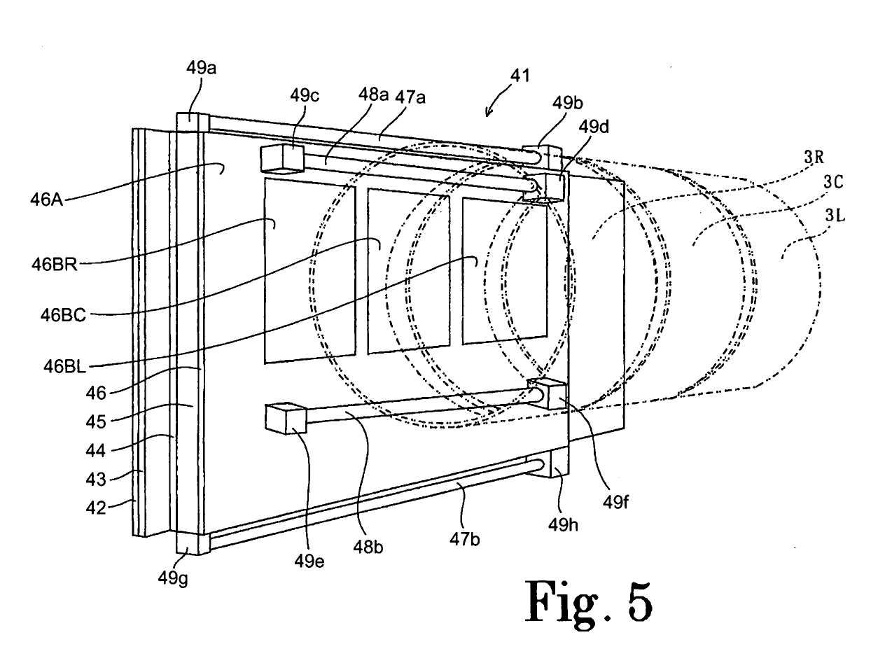

As shown in FIG. 2, the main display 5 is provided with symbol display areas, 21L, 21C and 21R, window frame display areas, 22L, 22C and 22R, and an effect display area 5a. Display contents of the main display 5 are to vary depending on a variable display mode and a stop display mode of the reels, 3L, 3C and 3R, as well as on the operation of the liquid crystal display unit 41 (refer to FIG. 5) to be explained later. The main display 5 is also provided with a BET number display part, a payout display part and a credit display part, which are, however, omitted in FIG. 2.

The symbol display areas, 21L, 21C and 21R, are provided so as to correspond to individual reels, 3L, 3C and 3R, respectively. The symbol display areas are provided such that symbols depicted on these reels, 3L, 3C and 3R can be recognized visually through the symbol display areas. Further, symbol display areas, 21L, 21C and 21R, provide a transmissive display enabling the player to visually recognize the rotating reels, 3L, 3C and 3R during scrolling symbols and the symbols themselves depicted thereon when the corresponding reels, 3L, 3C and 3R, are rotated and stopped. However, an effect display with a stationary image or a motion image such as a symbol, a letter, a diagram, a sign and a character is not made in the symbol display areas.

The window frame display areas, 22L, 22C and 22R, are provided so as to surround the corresponding symbol display areas, 21L, 21C and 21R, and may work as windows for displaying symbols depicted on these reels, 3L, 3C and 3R.

Further, the effect display area 5a is provided with an image for a special lottery game to be explained later. In addition, the effect display area 5a is provided with effects which increase an interest to the game and the information which is utilized by the player for conducting the game advantageously.

The sub display 4 is designed to vary the display contents depending on the operation of the liquid crystal display unit 101 to be explained later.

(Configuration of Reels)

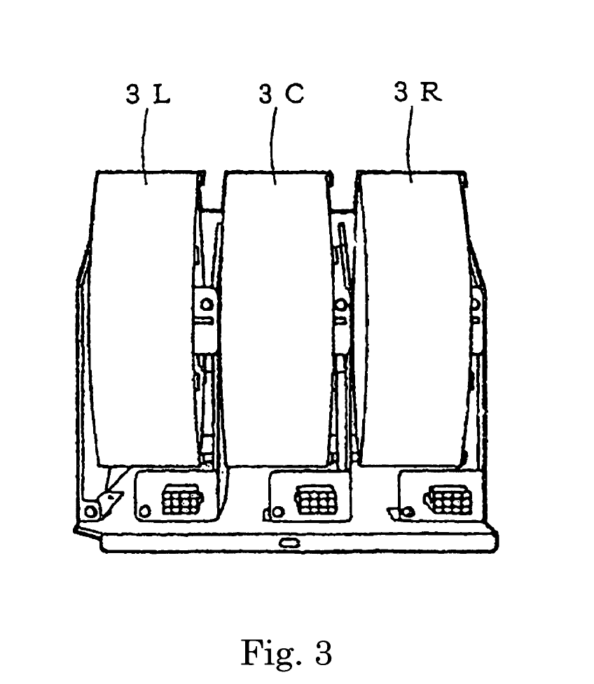

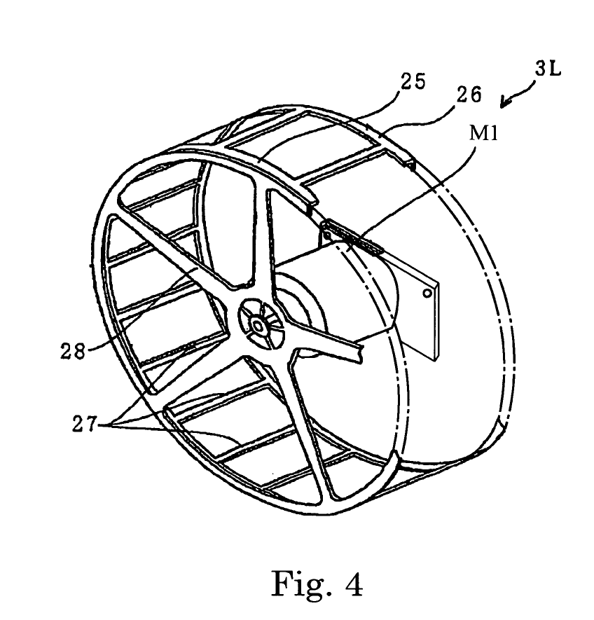

As shown in FIG. 3, individual reels, 3L, 3C and 3R, are disposed in a freely rotatable way along a single line from left to right and any one of the reels is configured in the same way. As shown in FIG. 4, the reel 3L is composed of a cylindrical frame, which is provided with two circular frames 25 and 26 with a similar shape such that the two circular frames 25, 26 are disposed with a predetermined distance and coupled with a plurality of connecting members 27. Further, as shown in FIG. 4, the reel 3L is provided with a transmission member 28 for transmitting, to the circular frames 25 and 26, a driving force from a stepping motor M1 (refer to FIG. 7) disposed at the center of the cylindrical frame, and a reel sheet (not illustrated) is attached to the side of the reel 3L so as to cover the connecting members 27. A plurality of symbols are depicted on the reel sheet. Further, although not illustrated, these reels 3L, 3C, 3R may be provided with circuit boards for accommodating LEDs and LED lamps behind symbols on three symbol windows of each of three columns formed by the three reels (9 symbols in total) which appear in the symbol display areas 21L, 21C and 21R when these rotating reels are stopped. In such configuration, it may be possible that each LED lamp emits white light to the main display 5 from the back of the reel sheet such that effect displays related with the contents of the game may be presented with a modified way of radiation.

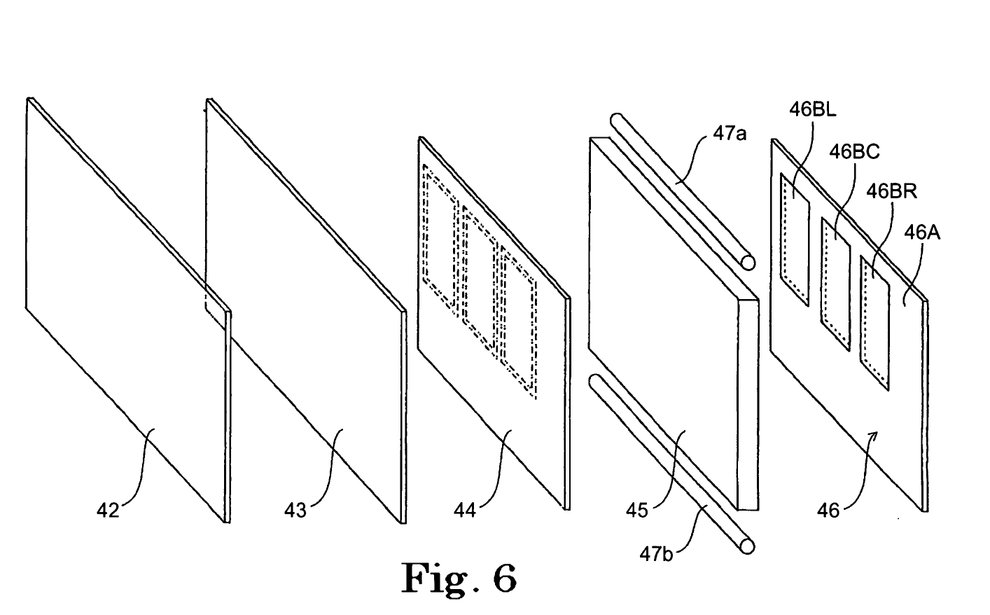

Next, an explanation will be made for the liquid crystal display unit 41 constituting the main display 5 by referring to FIGS. 5 and 6. FIG. 5 is a perspective view showing a general configuration of the liquid crystal display unit 41 when it is viewed from the back of the cabinet 2. FIG. 6 is an exploded perspective view showing a part of the liquid crystal display unit 41.

The liquid crystal display unit 41 is provided on the respective front faces of the reels, 3L, 3C and 3R, beyond these reels with a predetermined distance from these reels. The liquid crystal display unit 41 is also provided with a protective glass 42, a display plate 43, a liquid crystal panel 44 and a light guide plate 45. Further, it is provided with a reflection film 46, fluorescent lamps 47a, 47b, 48a and 48b (white light source), lamp holders 49a through 49h, and a flexible substrate (not illustrated) which is connected to the terminal of the liquid crystal panel 44 and constituted of a table carrier package (TCP) having an IC for driving the liquid crystal panel 44.

The protective glass 42 and the display plate 43 are optically transmissive. The protective glass 42 is provided mainly for protecting the liquid crystal panel 44. The display plate 43 is provided with predetermined images which are not illustrated.

The liquid crystal panel 44 is composed of a transparent substrate such as a glass plate on which a thin-film transistor is formed, a transparent substrate opposite thereto and liquid crystals provided and sealed between the two substrates such that the liquid crystal panel 44 forms the symbol display areas, 21L, 21C and 21R. This liquid crystal panel 44 is turned into a white display state (light is transmitted to the display surface and the transmitted light can be visually recognized from outside) if no voltage is applied to the liquid crystals (i.e., the liquid crystals are not driven) such that the liquid crystal panel may be configured in a normally white state where the reels 3L, 3C and 3R, can be visually recognized from the outer surface. Since the liquid crystal panel 44 is provided in such a normally white state, symbols depicted on these reels, 3L, 3C and 3R, can be visually recognized through the symbol display areas, 21L, 21C and 21R, even when the sealed liquid crystal cannot be driven. Therefore, the game can be played with visual recognition of the variable display and the stop display of each of the reels 3L, 3C and 3R.

The light guide plate 45 is optically transmissive and disposed on the back side of the liquid crystal panel 44 so as to introduce light from the fluorescent lamps, 47a and 47b, to the liquid crystal panel 44.

The reflection film 46 is provided for reflecting light introduced into the light guide plate 45 toward the surface of the light guide plate 45, and made with a white polyester film or an aluminum film on which silver film is evaporated. The reflection film 46 is provided with a reflective area 46A and non-reflective areas 46BL, 46BC, 46BR. The non-reflective areas 46BL, 46BC, 46BR, are made with transparent materials and formed as a light transmissive part which transmits light without reflecting incident light. Further, the non-reflective areas 46BL, 46BC, 46BR are formed corresponding to the symbol display areas 21L, 21C, 21R and disposed in front of three columns of symbols appearing when each of the rotating reels 3L, 3C, 3R is stopped. The reflective area 46A reflects incident light and functions as illumination means at areas mainly corresponding to window frame display areas 22L, 22C, 22R and the effect display area 5a in the total areas of the liquid crystal panel 44.

Fluorescent lamps 47a, 47b are disposed along the upper end and the lower end of the light guide plate 45, with the both ends supported by the lamp holders 49a, 49b, 49g, 49h. The fluorescent lamps 47a, 47b generate light which is guided into the light guide plate 45 and functions as illumination means at areas mainly corresponding to the window frame display areas 22L, 22C, 22R and the effect display area 5a in the total areas of the liquid crystal panel 44.

The fluorescent lamps 48a, 48b are disposed above and below at the back of the reflection film 46 toward each of the reels 3L, 3C, 3R. To be more specific, lights emitted from these fluorescent lamps 48a, 48b are reflected on each of the reels 3L, 3C, 3R entering into the non-reflective areas 46BL, 46BC, 46BR to radiate the liquid crystal panel 44. Therefore, the fluorescent lamps 48a, 48b function as illumination means of symbols disposed on each of the reels 3L, 3C, 3R and also functions as illumination means at areas corresponding to the symbol display areas 21L, 21C, 21R on the reflection film 46.

On the other hand, the liquid crystal display unit 101 is different from the liquid crystal display unit 41 in that a touch panel 56 to be explained later is not disposed in the front and the reels 3L, 3C, 3R are not disposed at the back. However, the rest components are similarly constituted.

(Internal Configuration of Slot Machine)

FIG. 7 is a block diagram of the slot machine 1A mainly showing the internal configuration of the machine. The slot machine 1A is provided with a plurality of components including a microcomputer 31 and a control board 71. The control board 71 is provided with the microcomputer 31, a random number generator 35, a sampling circuit 36, a clock pulse generating circuit 37 and a frequency divider 38, and also provided with a hopper driving circuit 63, a payout completion signal circuit 65, a sound control circuit 72 and an image control circuit 81.

The microcomputer 31 is provided with a CPU (central process unit) 32, a RAM (random access memory) 33 and a ROM (read only memory) 34. The CPU 32 operates as various means which may characterize features of the present invention. According to the programs stored in the ROM 34, the CPU 32 also makes signals inputted and outputted from and to other components via an I/O port 39, thereby conducting the whole operational control of the slot machine 1A. The RAM 33 stores data and programs used when the CPU 32 operates, temporarily retains random numbers sampled by the sampling circuit 36 to be explained later, for example, after the game is started, and also stores code numbers or symbol numbers of the reels 3L, 3C, 3R. The RAM 33 also stores temporarily a figure ID being read in a figure information reading process to be explained later. The ROM 34 stores programs executed by the CPU 32 and permanent data, for example, a high probability shift condition table to be explained later.

The random number generator 35 operates according to the instructions from the CPU 32 to generate a predetermined range of random numbers. According to the instructions from the CPU 32, the sampling circuit 36 extracts any given random number from random numbers generated by the random number generator 35, and inputs the extracted random number into the CPU 32. The clock pulse generating circuit 37 generates a reference clock for operating the CPU 32, and the frequency divider 38 inputs, to the CPU 32, a signal which divides the reference clock with a certain frequency.

Further, a reel driving unit 50 is connected to the control board 71. The reel driving unit 50 is provided with a reel position detection circuit 51 for detecting the respective positions of the reels 3L, 3C, 3R and a motor driving circuit 52 for inputting a driving signal to respective motors M1, M2, M3, which rotate these respective reels 3L, 3C, and 3R. When the driving signal is inputted from the motor driving circuit 52, motors M1, M2, M3 are driven to rotate the respective reels 3L, 3C, 3R. In addition, the control board 71 is connected with a spin switch 8, a single BET switch 9, a maximum BET switch 10, a coin insertion sensor 6a and a bill insertion sensor 7a. A signal is to be inputted from each of them.

The hopper driving circuit 63 drives a hopper 64 under the control of the CPU 32. The hopper 64 operates to pay out coins and actually pays out coins from a payout opening 13. A payout completion signal circuit 65 inputs data of the number of coins from a coin detection part 66 to which the circuit is connected and inputs, to the CPU 32, a signal notifying the completed payout of the coins when the number of coins has reached a predetermined number. The coin detection part 66 calculates the number of coins paid out from the hopper 64 and inputs the data of the calculated number of coins into the payout completion signal circuit 65.

Further, the sound control circuit 72 controls sound signals for generating sounds from speakers 12L, 12R according to the instructions from the CPU 32, and outputs sounds from the speakers 12L, 12R. Therefore, sounds for enlivening the game are generated from the speakers 12L, 12R, for example, at an appropriate timing after the game is started.

In addition, a touch panel 56 is connected to the CPU 32. The touch panel 56 is contact-type input means and provided so as to cover the surface of the protective glass 42 in the front face of the main display 5. The touch panel 56 detects a position on which the finger of the player and other parts of the body are touched (contact position) and inputs, into the CPU 32, the response input information corresponding to the contact position. For example, the touch panel 56 inputs, into the CPU 32, the information in association with a selection to play the game without the figure wherein the information is displayed on the main display 5.

The image control circuit 81 controls the respective image displays of a liquid crystal display unit 41 and a liquid crystal display unit 101.

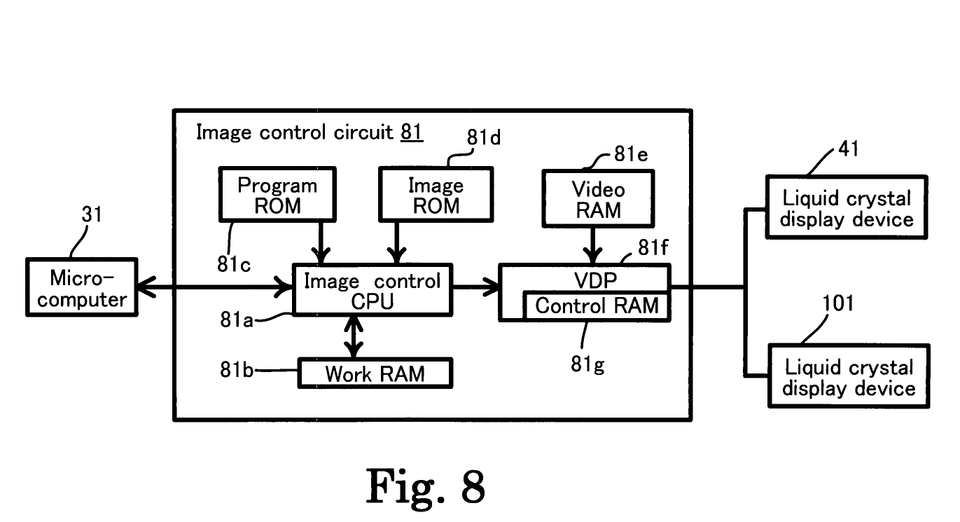

As shown in FIG. 8, the image control circuit 81 is provided with an image control CPU 81a, a work RAM 81b, a program ROM 81c, an image ROM 81d, a video RAM 81e and a VDP (video display processor) 81f. The image control CPU 81a determines an image to be displayed on the liquid crystal display unit 41 and the liquid crystal display unit 101 on the basis of the parameters established by the microcomputer 31 in accordance with the image control program (about display on the liquid crystal display unit 41 and the liquid crystal display unit 101) which is previously stored in the program ROM 81c. The work RAM 81b is constituted as temporary storage means when the image control CPU 81a executes the image control program.

The program ROM 81c stores the image control program and various selection tables. The image ROM 81d stores dot data for forming an image. The video RAM 81e is constituted as temporary storage means for forming an image by the VDP 81f. The VDP 81f is provided with a control RAM 81g, forming an image corresponding to the display contents of each of the liquid crystal display units 41 and 101 determined by the image control CPU 81a, and outputting the formed image respectively to the liquid crystal display units 41 and 101.

(Configuration of Figure)

As shown in FIG. 9, the figure 90 is provided with the base portion 91 and a figure main body 92 and also provided with an IC chip 93 which stores the figure ID.

The base portion 91 is available in a size corresponding to the base fitting portion 19a of the figure installation unit 19 and formed in a closed-end cylindrical shape having a top portion 91a. It is constituted in such a way that the IC chip 93 is fitted and fixed at the open end.

The figure main body 92 is provided with a seat portion 92a fixed at a top portion 91a of the base portion 91 and a three-dimensional configuration shaped so as to be erected from the seat portion 92a, and having a doll part 92b depicting a character such as a witch or a warrior. In the present embodiment, the figure 90 is equivalent to the game article of the present invention.

The IC chip 93 is storage means and stores the figure ID. The figure ID is composed of alphabetic letters and four-digit numbers. Alphabetic letters denote types of figures (for example, “A” is a witch; “B,” a warrior; “C,” a villager and the like) corresponding to the stereoscopic configuration at the figure main body 92, and the four-digit numbers denote unique identification information which identifies each figure (discrimination of oneself from others). In the figure 90, the player is able to recognize a type of character by referring to the three-dimensional configuration of the figure main body 92, and the slot machine 1A is able to recognize individual figures by referring to the figure ID. In the case of the figure 90 shown in FIG. 9, the figure ID is “B1001,” in which “B” is a type of character and “1001” is the identification information. In the present embodiment, “B1001” of the figure ID is equivalent to the game related information of the present invention.

(Operation Description of Slot Machine)

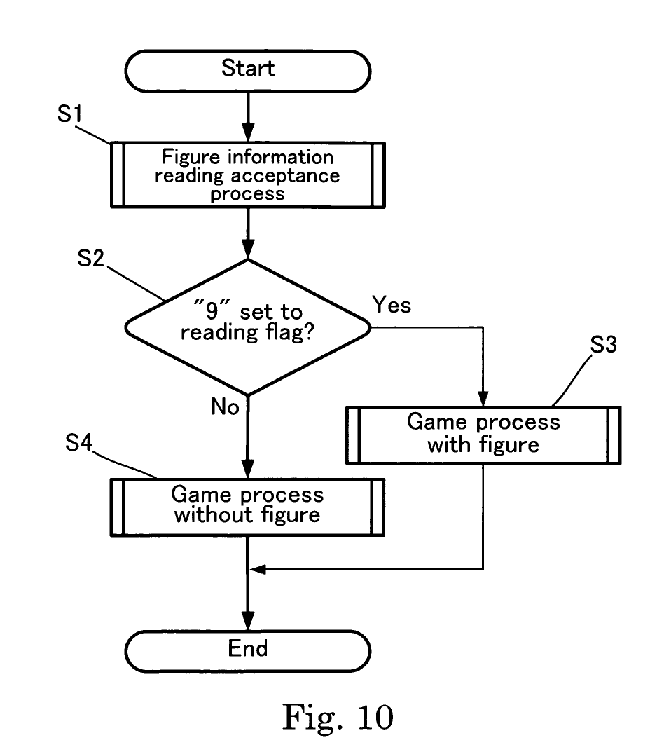

In the slot machine 1A of the present embodiment, the CPU 32 operates as game progress control means, thereby controlling the progress of the game in a base game mode and a special game mode. Further, in a figure-absent game process (game process without the figure) and a figure-present game process (game process with the figure) to be described later, a base game is conducted in the base game mode and a bonus game is conducted in the special game mode, respectively. Then, the figure-absent game process or the figure-present game process is determined by whether or not the figure ID is readable. The figure-present game process shifts more easily from the base game mode to the special game mode than the figure-absent game process. Hereinafter, an explanation will be made for the first operational example of the slot machine 1A by referring to the flow charts shown in FIGS. 10 to 13.

(First Operation Example)

FIG. 10 is a flow chart which shows block by block operational procedures for the first operational example of the main process from the start to the completion of the game in the slot machine 1A. In FIGS. 10 through 13, steps are abbreviated as “S.”

As shown in FIG. 10, when a main game process is started, the program in the slot machine 1A proceeds to the step 1 where selection is made on whether or not the player will conduct a figure-using game. Then, when the figure ID is read, a figure information reading acceptance process is conducted in the case where “9” is set to a reading flag to be explained later. When proceeding to a subsequent step 2, the process is determined depending on whether or not “9” is set to the reading flag. If it is set therein, the figure-present game process (step 3) is conducted. If it is not set, the figure-absent game process (step 4) is conducted. Upon completion of individual game processes, the main process is completed. Hereinafter, an explanation will be made in detail for individual blocks.

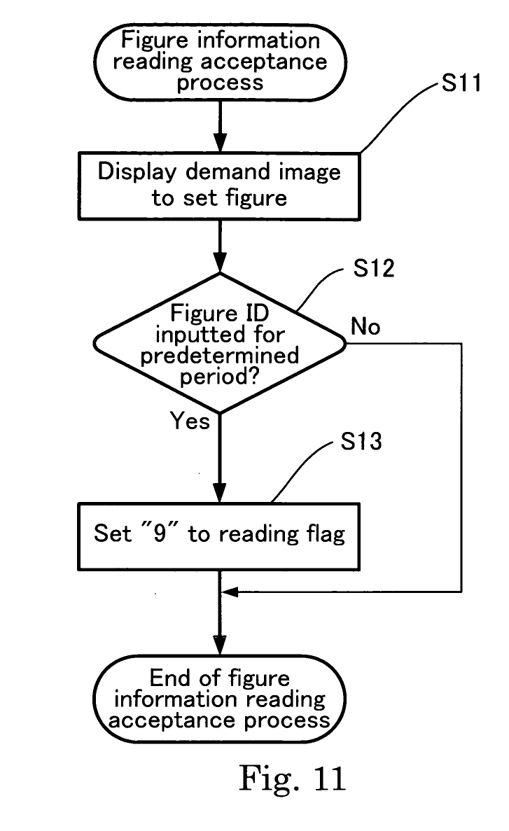

When proceeding to the step 1 where the figure information reading acceptance process is started, the program in the slot machine 1A proceeds to the step 11 as shown in FIG. 11 where the CPU 32 instructs the image control circuit 81 to display an image to demand for setting of a figure on the main display 5, while the CPU 32 instructs the circuit to display an image which demands the player to select “no figure” unless the player has a figure (hereinafter referred to as “demanding image”). According to the demanding image, the player having the figure 90 is able to set the FIG. 90 on the figure installation unit 19, while the player having no figure is able to select “no figure” by touching the touch panel 56. When the FIG. 90 is set on the figure installation unit 19, the IC chip reader/writer 19C reads the figure ID of the thus set figure 90 and inputs it into the CPU 32. Then, the figure ID is temporarily stored in the RAM 33, and the program in the slot machine 1A proceeds to a subsequent step 12. In the present embodiment, since the figure 90 is read, the figure ID to be inputted into the CPU 32 is “B1001.” On the other hand, when “no figure” is selected, the response input information corresponding to such selection is inputted into the CPU 32 from the touch panel 56.

When the program in the slot machine 1A proceeds to a subsequent step 12, the CPU 32 determines whether or not the figure ID is inputted. When the figure ID is inputted within a predetermined period of time from the IC chip reader/writer 19C, the program in the slot machine 1A proceeds to a step 13. In other cases, namely, when the figure ID is not inputted within the predetermined period of time and when the response input information corresponding to the selection of “no figure” is inputted from the touch panel 56, the figure information reading acceptance process is completed, without executing the step 13.

When it further proceeds to the step 13, predetermined information (for example, “9”) is set to a reading flag. The reading flag is reading determination information for determining whether or not the figure ID is readable, and the fact that “9” is set indicates that the figure ID is readable. When the reading flag is set, the figure information reading acceptance process is completed.

As shown in FIG. 10, when the program in the slot machine 1A proceeds to the subsequent step 2, the CPU 32 operates as reading determination means in the present invention and determines whether or not the figure ID is readable, depending on whether or not “9” is set to the reading flag. If “9” is set, the CPU 32 determines that the figure ID is readable and if it is not set, it determines that it is not readable. In the former case, it proceeds to the step 3 where the figure-present game process is conducted, and in the latter case, it proceeds to the step 4 where the figure-absent game process is conducted.

(Figure-Present Game Process)

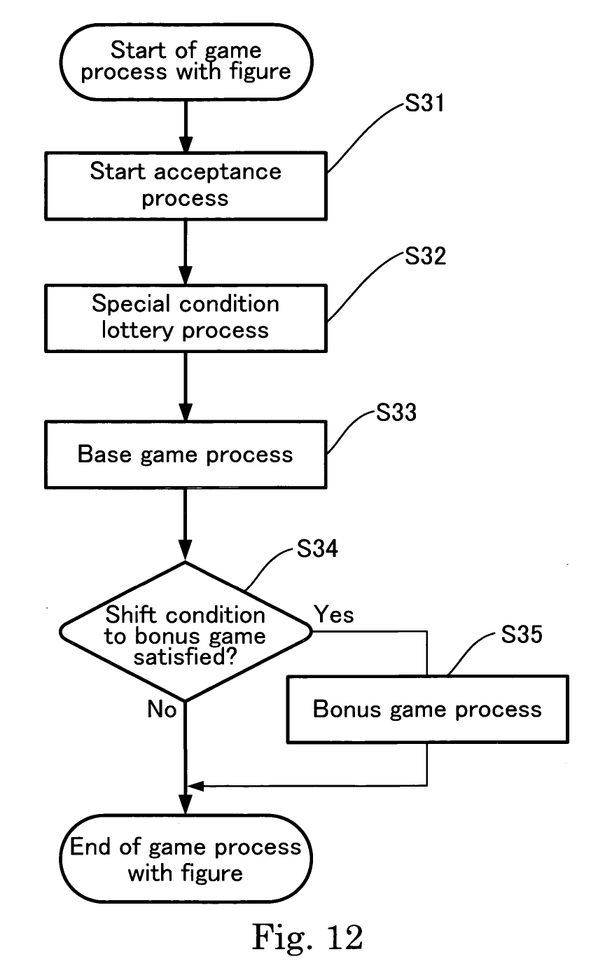

When the figure-present game process is started in the step 3, the program in the slot machine 1A proceeds to the step 31 in FIG. 12 to start the start acceptance process. When proceeding to the start acceptance process, the slot machine 1A accepts the operation for starting the game from the player in accordance with the control of the CPU 32. Since the slot machine 1A is a coin-insertion type gaming machine, at first, coins are inserted in the number to be bet on one game through the coin insertion slot 6 so that the player can start the game. Further, when the predetermined number of coins have been inserted and credits corresponding to the number of the thus inserted coins are available, either single BET switch 9 or maximum BET switch 10 is operated to use credits which are bet on one game. In the present embodiment, the coin is equivalent to or included by the game medium of the present invention, and the number of inserted coins is equivalent to the inserted number (i.e., the number of coins having been inserted). Further, the credit is equivalent to or included by the medium information corresponding to the number of game media, and the single BET switch 9 or the maximum BET switch 10 is operated to input, into the CPU 32, the information of the number of used credits. The CPU 32 operates as medium setting means for setting to start the base game. Then, when the spin switch 8 is operated (hereinafter, this operation is referred to as “start operation”), a start signal is inputted into the CPU 32 from the spin switch 8. The program in the slot machine 1A proceeds to the step 32.

When the program in the slot machine 1A proceeds to the step 32, a special condition lottery process is conducted, with the game mode kept in the base game mode. In the special condition lottery process, at first, the CPU 32 conducts a symbol determination process for determining a symbol to be stopped in each of the reels 3L, 3C, 3R on the winning line L1.

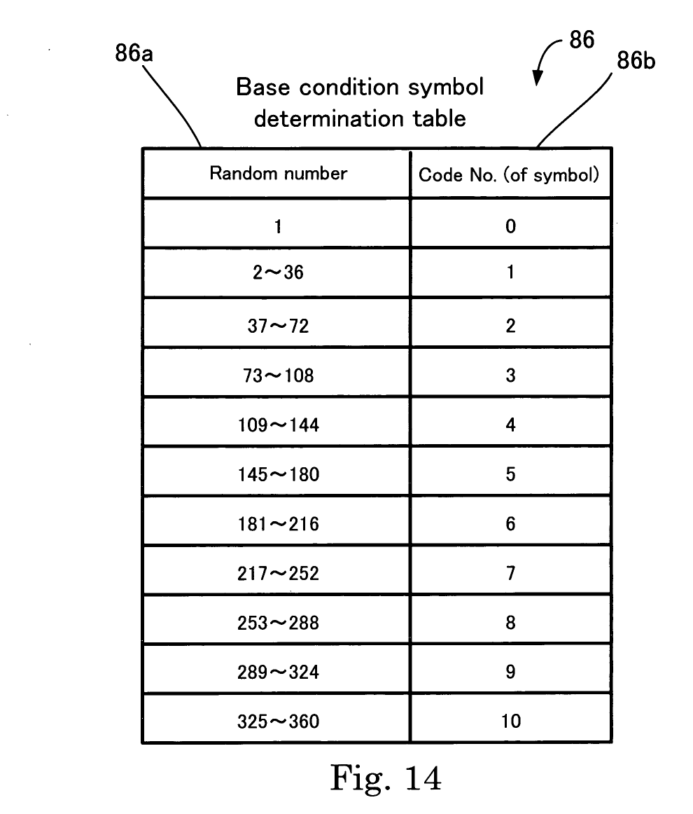

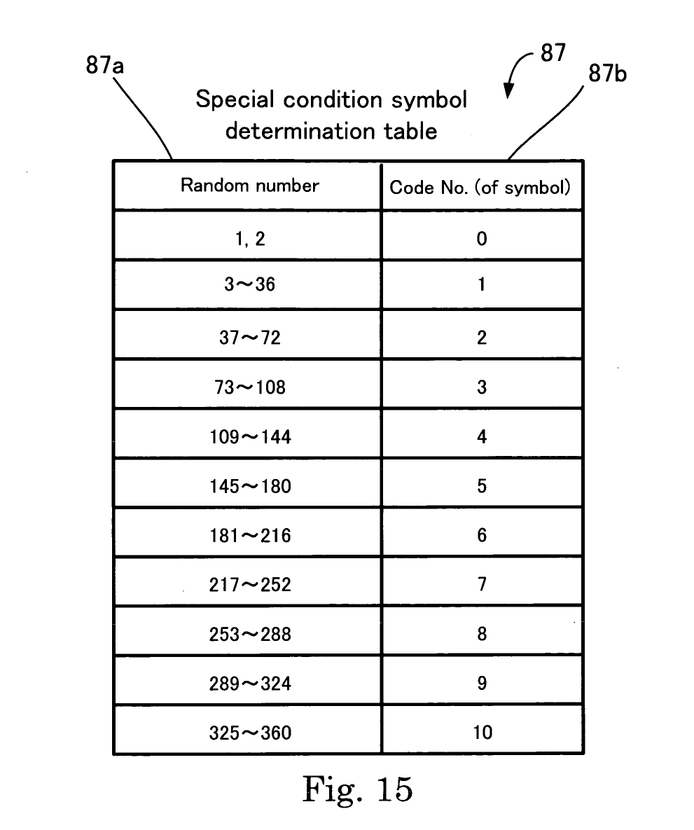

In this instance, when the CPU 32 detects the start operation by the player on the basis of the start signal from the spin switch 8, it instructs the random number generator 35 to generate random numbers in a certain range and also instructs the sampling circuit 36 to extract any given random number which is generated by the random number generator 35. When a random number is extracted, the CPU 32 sets the number as a search key and obtains the code number of the corresponding symbol by referring to a base condition symbol determination table 86 (refer to FIG. 14) and a special condition symbol determination table 87 (refer to FIG. 15) stored in the ROM 34. The base condition symbol determination table 86 is referred to for obtaining the code number of the symbol about the reels 3L and 3R (right and left reels) and the special condition symbol determination table 87 is referred to for obtaining the code number of the symbol about the reel 3C (central reel).

In this instance, as shown in FIGS. 14 and 15, these symbol determination tables 86 and 87 are provided with code number fields 86b and 87b (of the symbol) for storing the code number of the symbol and random number fields 86a and 87a for storing random numbers in a predetermined range associated with the code number of the symbol. In the present embodiment, as will be explained later, when the WILD symbol corresponding to code number “0” of the symbol appears on any one of three reels 3L, 3C, 3R along the winning line L1, the game will shift to the bonus game. Therefore, a probability of shifting to the bonus game (probability of shifting from the base game mode to the special game mode) is determined by a predetermined range of random numbers associated with the code number “0” of the symbol.

When referring to the base condition symbol determination table 86, a predetermined range of random numbers associated with the code number “0” of the symbol is only “1.” Therefore, a probability that the WILD symbol appears either on the reel 3L or on the reel 3R (right and left reels) is “1/180,” as shown in the following formula (1). On the other hand, when referring to the special condition symbol determination table 87, a predetermined range of random numbers associated with the code number “0” of the symbol is “1 and 2.” Therefore, a probability that the WILD symbol appears on the reel 3C (central reel) is “1/180” as shown in the formula (2). A probability that the WILD symbol appears on any one of the reels, 3L, 3C and 3R, is “1/90” as shown in the following formula (3).
2(number of reels)×1(predetermined range of random numbers)/360(total random numbers)=1/180 (1)
1(number of reels)×2(predetermined range of random numbers)/360(total random numbers)=1/180 (2)
(1)+(2)=1/90 (3)

As explained so far, in the figure-present game process, a probability of shifting from the base game mode to the special game mode is set to be “1/90.” However, as will be explained later, in the figure-absent game process (refer to the step 4 in FIG. 10), a probability of shifting from the base game mode to the special game mode is set to be “1/120,” and in figure-present game process it is more likely to shift the base game mode to the special game mode than in the figure-absent game process. To be more specific, in the present embodiment, the shift condition from the base game mode to the special game mode in the figure-absent game process (appearance of the WILD symbol) is correspondent to (or included by) the first shift condition of the present invention, and the shift condition from the base game mode to the special game mode in the figure-present game process (appearance of the WILD symbol) is correspondent to the second shift condition of the present invention.

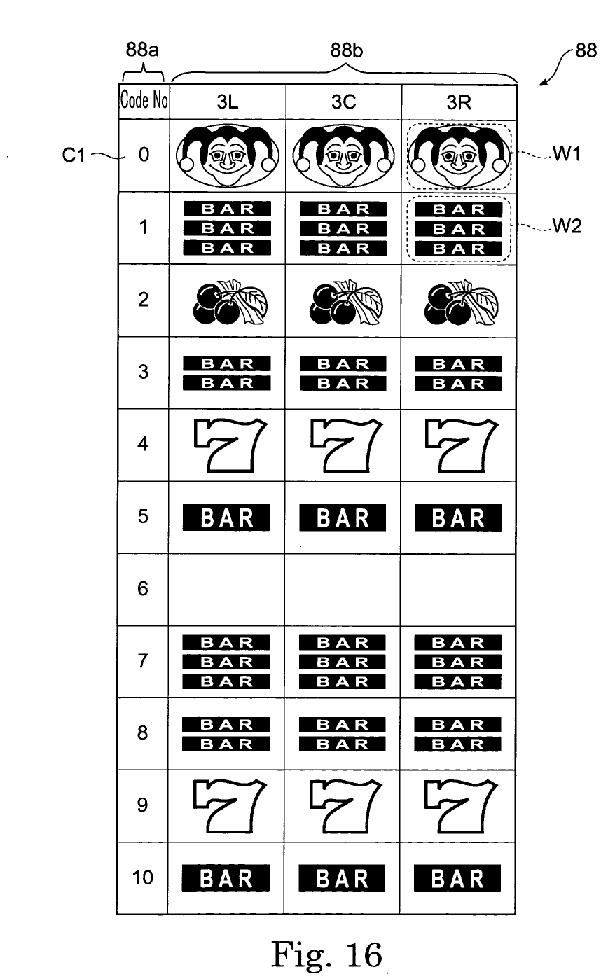

Next, the obtained code number of the symbol is set in a search key, and a symbol of each of the reels 3L, 3C, 3R displayed on an activated line when stopped is searched by referring to a stop table 88 shown in FIG. 16.

In this instance, as shown in FIG. 16, the stop table 88 is a table having a code number field 88a which stores code numbers (of symbols) and a symbol field 88b which stores symbols associated with each of the code numbers. The table is designed so as to enable searching for a symbol corresponding to each of the reels 3L, 3C, 3R by setting the code number in the search key and searching the code number field 88a. Then, C1 in FIG. 16 shows a combination of symbols being composed of the symbols when the obtained code number is “0” for all the reels 3L, 3C, 3R. Further, the symbol shown with W1 is a joker (WILD symbol) or an advantageous symbol which forms a winning mode to be explained later in any combination with other symbols. In the present embodiment, appearance of a joker (WILD symbol) indicates a bonus game shift condition (shift condition from the base game mode to the special game mode).

In the slot machine 1A, these random numbers are extracted and the symbol determination table and the stop table are searched three times in total for each of the reels 3L, 3C, 3R. To be more specific, such actions are taken at the number of times corresponding to the number of reels. When a symbol is determined for each of the reels 3L, 3C, 3R, a stop position of the reel for stopping the symbol along the winning line L1 is determined.

When a stop position of the reel is determined, with reference to a winning determination table stored in the ROM 34 (table in which winning combinations of symbols and non-winning combinations of symbols which are not winning (non-winning) are registered in an identifiable way in association with combinations of each code number (hereinafter referred to as “code number pattern”)), the CPU 32 conducts a winning determination process for determining the winning by using the code number pattern.

Then, the CPU 32 operates as winning mode determination means in the present invention to conduct a winning mode determination process for determining a winning mode by referring to a mode table which registers payouts according to the winning mode (“winning mode” is also called “winning combination”). This mode table is referred to in such a way, for example, that the game mode shifts from the base game mode to the special game mode upon appearance of a winning combination of “jokers,” or that five coins are paid out on appearance of “3BAR-3BAR-3BAR” in which the symbols being composed of “BAR” arranged vertically in three (3BAR: the symbol indicated with W2 in FIG. 16) are arranged in three.

As explained above, the special condition lottery process is completed, and the program in the slot machine 1A proceeds to a subsequent step 33 where a base game process is conducted. In this instance, after the reels 3L, 3C, 3R are rotated, they are stopped so as to correspond to the result of the special condition lottery process in the step 32. When the winning is obtained, coins are paid out according to the payout of the winning mode and it proceeds to the step 34.

When the program in the slot machine 1A proceeds to the step 34, the CPU 32 operates as shift determination means in the present invention to make a shift determination for determining whether or not the game shifts to the bonus game by referring to the result of the special condition lottery process in the step 32 (shift determination by the second shift condition). In this instance, it is determined that the game should shift when the previously described WILD symbol W1 appears. At this time, the CPU 32 operates as shift means in the present invention to shift the game mode from the base game mode to the special game mode and conduct the bonus game process in the step 35. On the other hand, where the shift condition is not satisfied, the figure-present game process is terminated.

When the bonus game process is started in a subsequent step 35, a symbol determination process similar to the above-described special condition lottery process, a winning determination process and a winning mode determination process are conducted by a predetermined number of times in which a free game is conducted (for example, three times). Then, on the basis of the lottery result, these reels 3L, 3C, 3R are rotated and stopped by a predetermined number of times. When having obtained the winning, coins are paid out according to the payout of the winning mode. The bonus game process is completed and the figure-present game process is then completed.

In the base game process and the bonus game process, when the winning is determined on the basis of the result of the special condition lottery process, the CPU 32 instructs the hopper driving circuit 63 to pay to the player a predetermined number of coins depending on the winning mode concerned. The number of coins paid out at this time is equivalent to the number of paid-out coins in the present invention.

(Figure-Absent Game Process)

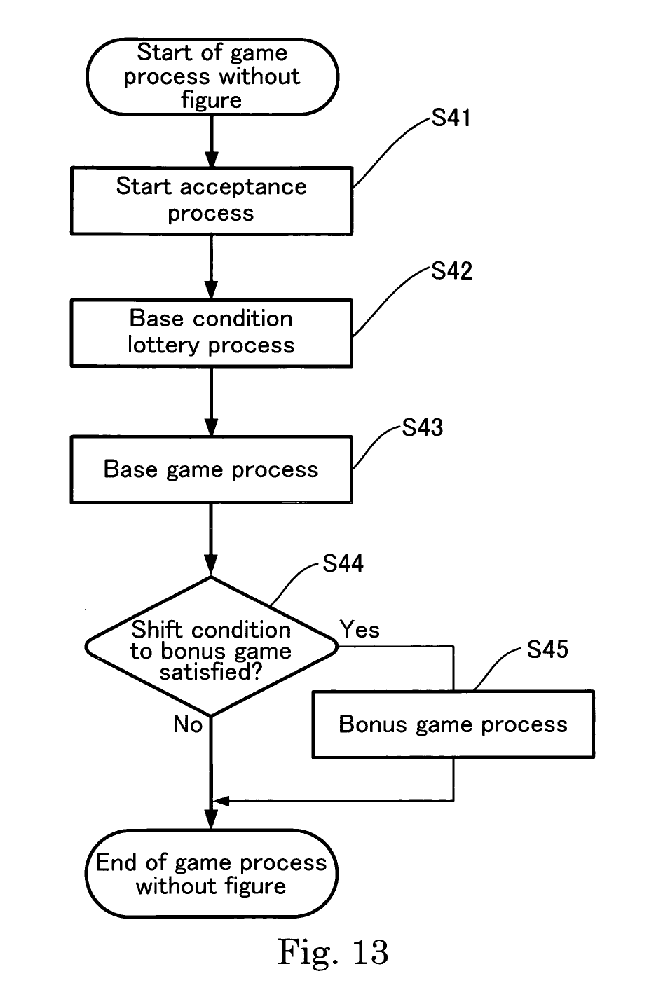

On the other hand, when it is determined that “9” is not set to a reading flag in the step 2 shown in FIG. 10, the program in the slot machine 1A proceeds to the step 4 where the figure-absent game process is conducted. When the figure-absent game process is started, a start acceptance process (step 41), a base condition lottery process (step 42) and a base game process (step 43) are conducted as shown in FIG. 13. Then, when the predetermined condition (the first shift condition) is satisfied on the basis of the result of the base condition lottery process (step 42), the game shifts to the special game mode after the base game process (step 43) and the bonus game process (step 45) is conducted. The start acceptance process (step 41), the base game process (step 43) and the bonus game process (step 45) are similar to those in the figure-present game process. Therefore, a detailed explanation is omitted for these processes, and hereinafter an explanation will be made in detail for the base condition lottery process (step 42).

When the base condition lottery process is started, similarly with the previously described special condition lottery process (refer to the step 32 in FIG. 12), the symbol determination process, the winning determination process and the winning mode determination process are conducted. However, in the symbol determination process where code numbers of all the symbols for the reels 3L, 3C, 3R are obtained, reference is made to the base condition symbol determination table 86 (refer to FIG. 14). The base condition game process is to shift the base game to the bonus game on appearance of the WILD symbol, similarly with the special condition game process. However, in the base condition game process, a probability of shift to the bonus game (probability of shift from the base game mode to the special game mode) is set to be 1/120 as shown in the following formula (4).
3(number of reels)×1(predetermined range of random numbers)/360(total random numbers)=1/120 (4)

In the slot machine 1A of the first operational example, a figure-present game process or a figure-absent game process is determined by whether or not the figure ID is readable. The figure-present game process is designed to shift more easily from the base game mode to the special game mode than the figure-absent game process.

Therefore, newness and novelty associated with a change in shift conditions may be given to the player who is in anticipation of the shift from the base game to the bonus game (shift from the base game mode to the special game mode), thereby making it possible to motivate the player to play the game, without lowering a sense of anticipation, and also provide an incentive to play the game repeatedly. In particular, since the figure-present game process with a higher probability of shift is conducted under the condition that the figure ID (game related information) stored in the figure (game article) has been read, the player can be motivated to keep the figure as if it were a lucky charm. Therefore, the player has a greater attachment to the figure and can also be motivated to collect figures more passionately.

(Second Operational Example)

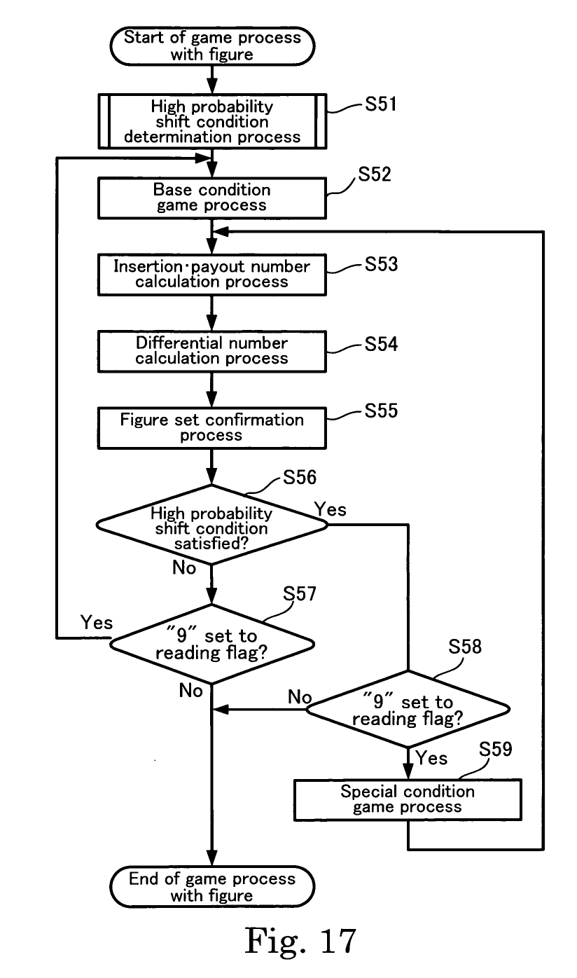

Then, an explanation will be made for the second operational example of the slot machine 1A. The slot machine 1A in the second operational example is subjected to substantially similar processes given in the first operational example except for the figure-present game process (refer to the step 3 in FIG. 10). However, in the second operational example, in order to easily shift to the special game mode, it is necessary that “9” is set to the reading flag and also a high probability shift condition to be explained later (the third shift condition in the present invention) is satisfied in the figure-present game process. When “9” is determined to be set to the reading flag in the step 2 of FIG. 10, the program in the slot machine 1A proceeds to the step 3 where a figure-present game process is started. When the figure-present game process is started, the figure-present game process is to be started as shown in FIG. 17. Hereinafter, an explanation will be made mainly for the figure-present game process related to the second operational example by referring to FIG. 17. FIG. 17 is a flow chart showing the operational procedures for the figure-present game process related to the second operational example, in which steps are abbreviated as “S.”

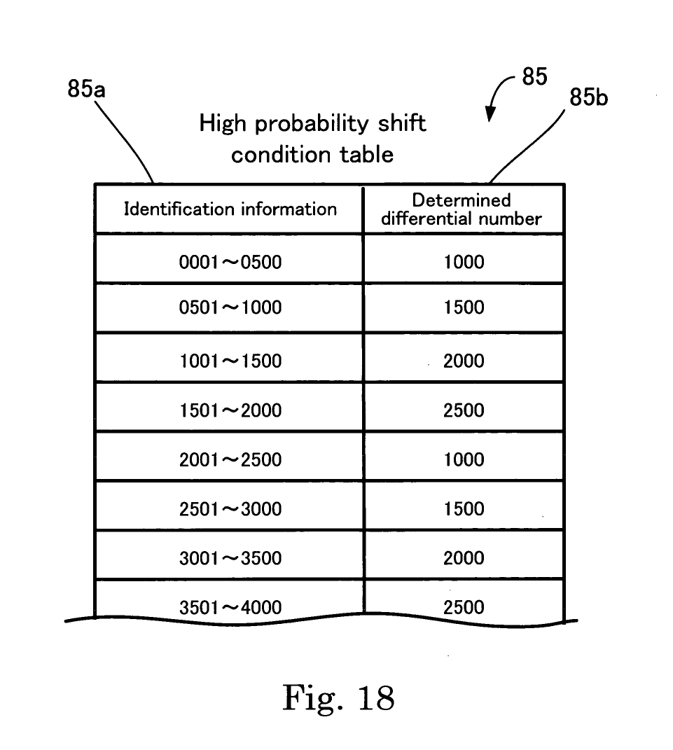

When the figure-present game process is started, the program in the slot machine 1A proceeds to the step 51 in FIG. 17 where a high probability shift condition determination process is started. In the high probability shift condition determination process, the CPU 32 operates as shift condition setting means to obtain identification information from the figure ID stored in the RAM 33. Then, the CPU 32 sets the identification information in a search key and sets the high probability shift condition on the basis of the corresponding determined differential number by referring to a high probability shift condition table 85 (refer to FIG. 18). The thus obtained determined differential number is used as a threshold value for determining whether or not a high probability shift condition to be explained later is satisfied. FIG. 18 shows an example of the high probability shift condition table. The table has an identification information field 85a which stores the identification information discriminated for each predetermined range (every 500 from “0001” in the present embodiment) and a determined differential number field 85b which stores the determined differential number associated with a predetermined range discriminated by the identification information field 85a. In the present embodiment, the figure ID stored in the RAM 33 is “B1001” and the identification information is “1001.” Therefore, the determined differential number “2000” is set by referring to the high probability shift condition table 85. Although explained later in detail, an excess over the determined differential number is a high probability shift condition, constituting the third shift condition in the present invention. The program in the slot machine 1A proceeds to the step 52 after the high probability shift condition is set.

When the program in the slot machine 1A proceeds to the step 52, a base condition game process is conducted. Since the base condition game process is subjected to the same process as the figure-absent game process in the first operational example, a detailed explanation is omitted.

Then, when it proceeds to a subsequent step 53, an insertion-payout number calculation process is conducted. In the insertion-payout number calculation process, the CPU 32 operates as calculation means for calculating the number of coins (number of inserted coins) and the number of credits (number of used media showing the number of game media) inserted or used by the player in the base condition game process (step 52) and the special condition game process (step 59) to be explained later, to store, in the RAM 33, a sum of the number of coins and the number of credits that are calculated. The CPU 32 also computes a total number of coins (the number of paid-out coins) paid regarding the base game process and the bonus game process in the base condition game process and the special condition game process to be explained later (step 59) and stores the result in the RAM 33. In this instance, where certain conditions to be explained later are met, the base condition game process and the special condition game process are repeated. Therefore, when a sum of the number of inserted coins and the number of credits as well as a total number of coins paid out have already been stored in the RAM 33, the number obtained by adding a newly calculated number to the sum of already stored numbers is stored in the RAM 33.

As explained so far, the insertion-payout number calculation process is conducted, after the figure ID is read, each time when the base game process (step 52) and a special condition game process to be explained later (step 59) are completed. However, this process is designed not to be conducted, if the reading flag “9” is cleared in the step 55 to be explained later.

When the program in the slot machine 1A proceeds to a subsequent step 54, the CPU 32 operates as differential number calculating means in the present invention, subtracting a total number of paid-out coins from a total number of inserted coins and a total number of credits stored in the RAM 33, and storing the differential number obtained by the subtraction in the RAM 33.

When the program in the slot machine 1A proceeds to a subsequent step 55, a figure set confirmation process is conducted. In the figure set confirmation process, the CPU 32 clears a reading flag on the basis of a detection signal input from the figure detection sensor 19d when the FIG. 90 is not set, and it proceeds to the step 56.

In the step 56, the CPU 32 operates as determination means for determining whether or not the third shift condition is satisfied to determine whether or not the differential number stored in the RAM 33 is in excess of the determined differential number set in the previously described step 51. In this instance, when the differential number exceeds the determined differential number, it is determined that the high probability shift condition is satisfied. The program in the slot machine 1A proceeds to the step 58, or to the step 57 if it is not determined so. In the present embodiment where the determined differential number is set to be “2000,” if the differential number determined in the step 54 is in excess of 2000, the high probability shift condition is satisfied, and the slot machine 1A proceeds to the step 58.

In the step 58, the CPU 32 again determines whether or not “9” is set to a reading flag. If it is set, the program in the slot machine 1A proceeds to the step 59 where the special condition game process is conducted, and if it is not set, the figure-present game process is completed. Therefore, a determination is made again for whether or not “9” is set to the reading flag because there is a case where the reading flag is cleared in the step 55. In the step 55, the reading flag is cleared when the figure 90 is removed from the figure installation unit 19. Namely, when the FIG. 90 is removed, the slot machine 1A will not proceed to the special condition game process, thereby completing the figure-present game process and also the main process shown in FIG. 10.

Similarly with the figure-present game process (refer to FIG. 12) explained in the first operational example, the special condition game process in the step 59 conducts the base game in the base game mode and the bonus game (free game conducted for a predetermined number of times) in the special game mode. Then, in this instance, since a probability of shift from the base game mode to the special game mode is set to be “1/90” as explained previously, it may easily shift to the special game mode.

On completion of the special condition game process, the program in the slot machine 1A proceeds to the step 53 where the insertion-payout number calculation process and subsequent various processes are conducted. As long as it is determined that “9” is set to the reading flag and also the high probability shift condition is satisfied, the special condition game process (step 59) is repeated.

On the other hand, when the program in the slot machine 1A proceeds from the step 56 to the step 57, the it is determined whether or not “9” is set to the reading flag. If it is determined to be set thereon, it returns to the step 52 where the base condition game process is conducted. If it is not determined so, the figure-present game process is completed and the main process is also completed. Where the figure 90 is removed in the course of a game, the reading flag is cleared in the previously described step 55. Therefore, the figure-present game process is completed and the main process is also completed.

Further, in the second operational example, as explained above, where the figure 90 is removed to clear the reading flag, the figure-present game process is to be completed. However, the figure-present game process may be completed, where the bonus game is conducted in the special condition game process (step 59 in FIG. 17).

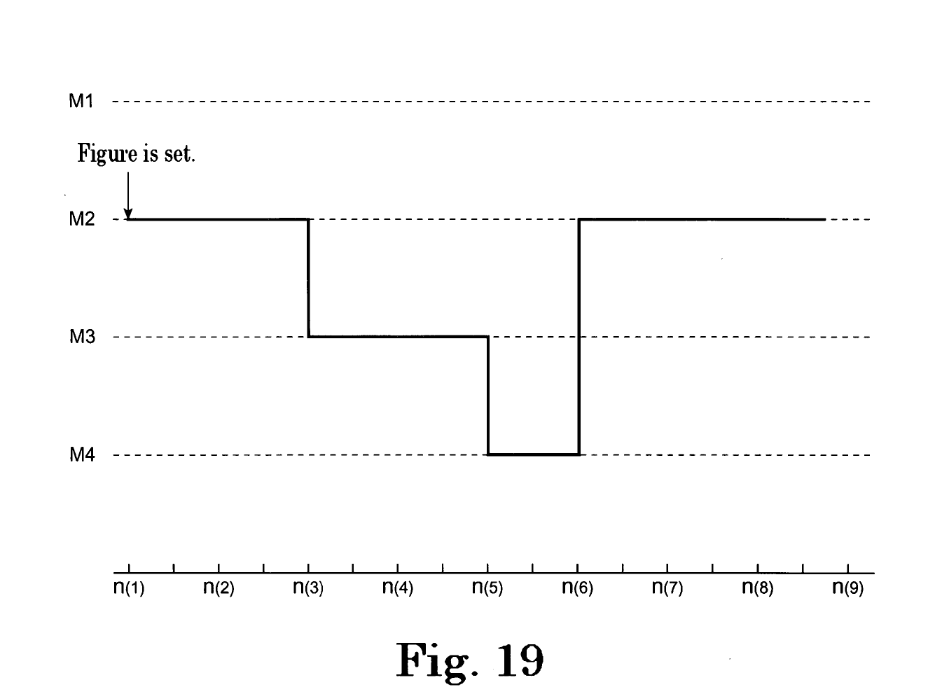

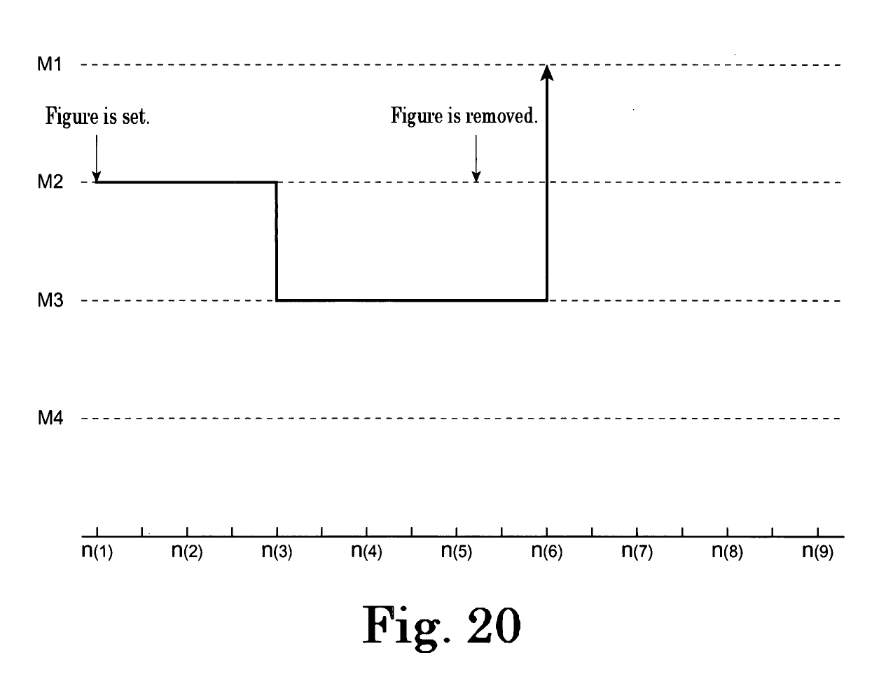

Next, an explanation will be made for the change in the game mode in the second operational example of the slot machine 1A by referring to timing charts given in FIGS. 19 and 20. In FIGS. 19 and 20, the base game and the bonus game (free game to be performed for a predetermined number of times is counted as one bonus game) conducted repeatedly are indicated in an identifiable way by n (i) (i: integer number), and a number in parentheses (i) indicates the number of games conducted consecutively. Further, the base game mode where no figure is set is denoted by M1, the base game mode at the base probability (the first shift condition) where the figure is set is denoted by M2, the base game mode at the high probability (the second shift condition) is denoted by M3, and the special game mode at the high probability (second shift condition) is denoted by M4. The solid line shows which game mode the concerned game mode is in.

In the timing chart shown in FIG. 19, the figure ID is read by setting the figure 90, thereby conducting the figure-present game process (step 3 in FIG. 10), and the game mode remains in the base game mode M2 (step 52 in FIG. 17) at the base probability from n (1) to completion of game n (2). Then, when the differential number is in excess of the determined differential number on completion of the game of n (2) and the high probability shift condition is satisfied, the game shifts to the base game mode M3 at the high probability (step 59 in FIG. 17). Thereafter, in the game of n (4), the bonus game shift condition is satisfied and in the game of n (5), the game shifts from the base game mode M3 to the special game mode M4. Then, a large number of coins are paid out when the winning is obtained in the bonus game (free game) conducted in the special game mode M4, and the differential number is reduced from the game of n (6) and the high probability shift condition is not met (step 56 in FIG. 17). Again, the game shifts back to the base game mode M2 (step 52 in FIG. 17).

In the timing chart shown in FIG. 20 as well, the figure-present game process is conducted by setting the figure 90 (step 3 in FIG. 10), and the game mode remains in the base game mode M2 (step 52 in FIG. 17) at a base probability from n (1) to completion of game n (2). When the differential number is in excess of the determined differential number on completion of the game of n (2) and the high probability shift condition is satisfied, the game shifts to the base game mode M3 at the high probability (step 59 in FIG. 17). Thereafter, the figure is removed in the course of the game of n (5) and the reading flag is cleared (step 55 in FIG. 17). The game process where the figure is set is terminated and the game shifts to the base game mode M1 where no figure is set.

Therefore, in the slot machine 1A which has been so far explained in the second operational example, game related information read by the reading means is used to establish the third shift condition. Whether or not the second shift condition is satisfied is to vary, depending on whether or not the third shift condition is met. Therefore, change in the figure may result in change in the second or the third shift condition to be satisfied and also may result in change in the shift condition of the bonus game. Then, in the slot machine 1A, when the figure is changed, the player is given an incentive to play the game, anticipating that this figure may be more likely to lead to the bonus game.

Further, since the determination of whether or not the high probability shift condition is satisfied is made by referring to the differential number which is a difference between the number of inserted coins or credits and the number of coins paid out, it is possible to give, to the player who has lost greatly (loser), a condition more easily shifted to the special game mode than the winning player, thereby providing the loser with an advantage for continuing the game or offering an incentive to repeat the game.

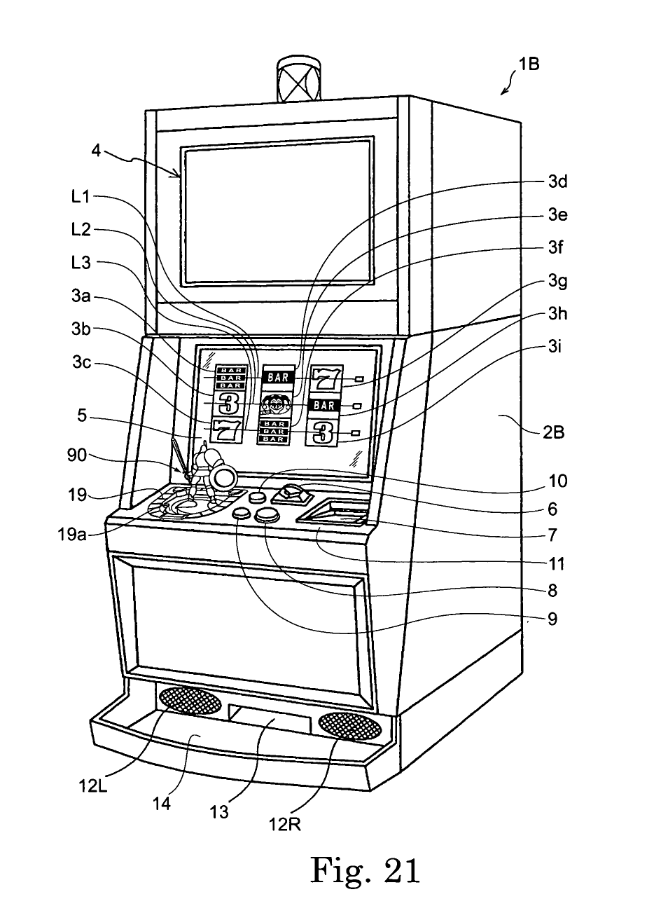

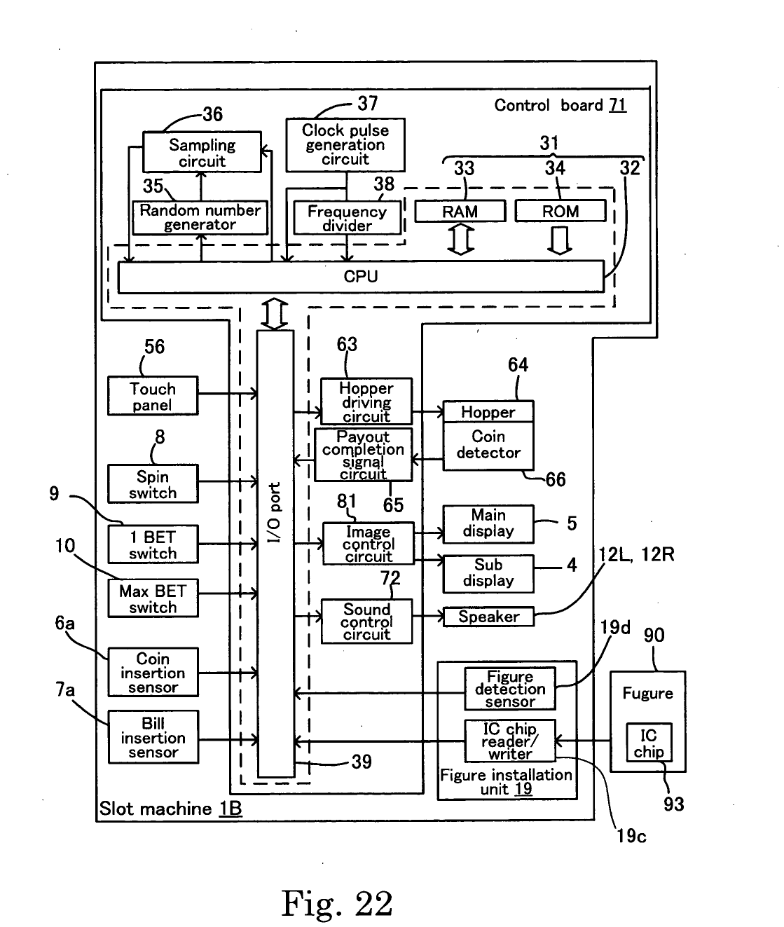

Then, an explanation will be made for the slot machine 1B of the embodiment 2 by referring to FIG. 21. FIG. 21 is a perspective view showing a general configuration of the slot machine 1B of the present embodiment, and FIG. 22 is a block diagram of the slot machine 1B which mainly shows the internal constitution.

The slot machine 1B is provided with plural arrays (three arrays) of the variable display parts which display variable display images of a plurality of symbols in place of the reels 3L, 3C, 3R of the slot machine 1A, and constituted so as to conduct a variable display image game (video slot game) by using variable display images displayed at individually variable display parts.

Similarly with the slot machine 1A, the slot machine 1B also uses the identification information of the figure ID to conduct the high probability shift condition determination process. The high probability shift condition depends on whether or not the differential number exceeds the determined differential number. Hereinafter, an explanation will be made for the constitution of the slot machine 1B. However, the slot machine 1B is substantially similar in configuration to the slot machine 1A and the same symbols used in the slot machine 1A are given to the same components such that a detailed explanation may be omitted.

The main display 5 of the slot machine 1B has a total of nine variable display parts (3a, 3b, 3c, 3d, 3e, 3f, 3g, 3h and 3i) which are disposed in three arrays both vertically and horizontally. The main display 5 is designed in such a way that a scroll display image (reel image to be displayed as if a mechanical reel were rotated) can be displayed in the base game mode (base game) and the special game mode (free game) as if a plurality of symbols moved from top to bottom at each of the variable display parts 3a through 3i. Further, in FIG. 21, activated lines (L1 to L3) are provided in three vertical arrays. However, eight activated lines in total may be provided in arrays including three vertical arrays and three horizontal arrays in variable display parts 3a through 3i as well as diagonal arrays.

As shown in FIG. 21, the slot machine 1B is provided with a plurality of components including a microcomputer 31. The CPU (central processing unit) 32 operates as shift determination means, shift means, reading determination means, shift condition setting means, differential number calculating means, medium setting means and calculation means of the present invention. The IC chip reader/writer 19c is equivalent to (or included by) reading means.

Then, an explanation will be made for operational description of the slot machine 1B. A main process of the slot machine 1B is substantially similar to that of the slot machine 1A but different in the symbol determination process conducted in the base condition lottery process and the special condition lottery process. To be more specific, in the slot machine 1B, a symbol (hereinafter, this symbol is referred to as “stop symbol”) is determined, which is stopped from being displayed variably but displayed in a fixed way at each of the variable display parts 3a through 3i. Then, appearance of the WILD symbol (refer to W1 in FIG. 16) is regarded as the shift condition to the bonus game (shift condition from the base game mode to a special game mode). Therefore, the probability at which the WILD symbol is stopped and determined as a stop symbol is made higher in the figure-present game process (special condition game process) than in the figure-absent game process, thereby making it easier to shift from the base game mode to the special game mode. Further, in the slot machine 1B where the reels 3L, 3C, 3R are not used, no restrictions are placed on the number of symbols, thereby making it possible to change a probability of shift by freely changing the types of the symbol corresponding to random numbers.

The slot machine 1B also has the same actions and effects as the slot machine 1A, giving newness and novelty associated with the change in shift conditions to the player who anticipates shift from the base game to the bonus game (shift from the base game mode to the special game mode), thereby motivating the player to play the game without lowering a sense of anticipation for the game and making it possible to give an incentive to play the game repeatedly.

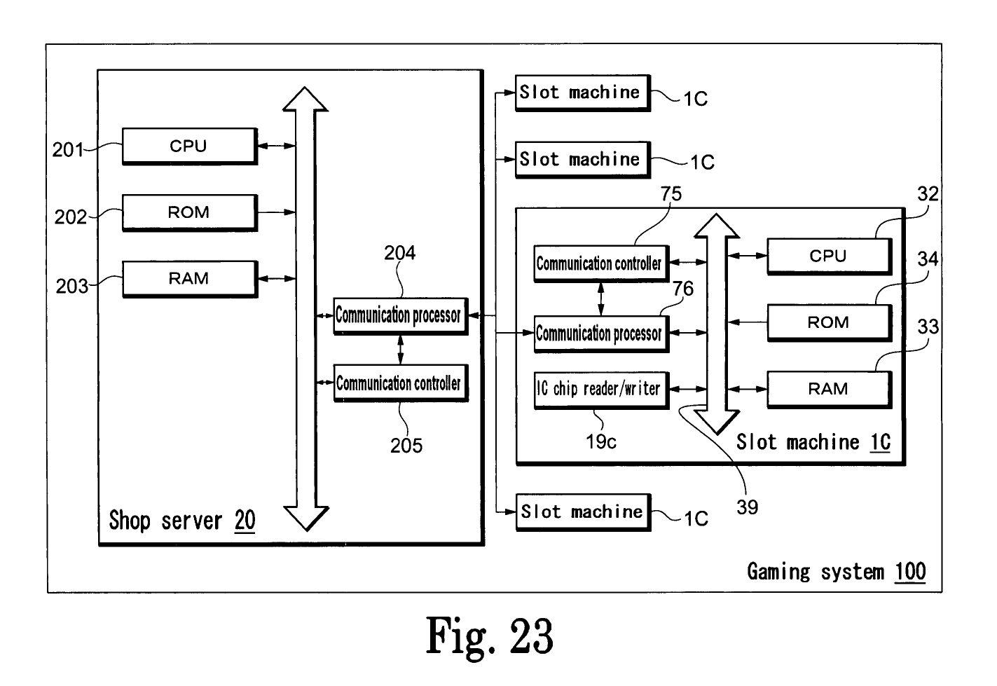

Then, an explanation will be made for the embodiment related to the gaming system of the present invention. FIG. 23 is a block diagram showing a general configuration of the gaming system of the present embodiment. The gaming system 100 is provided with a shop server 20 installed at a gaming shop and a plurality of slot machines 1C (four units in the present embodiment) connected communicatively with the shop server 20. In the gaming shop, the shop server 20 is connected to each of the slot machines 1C via dedicated lines to form an in-shop LAN.

The shop server 20 is equivalent to the gaming server of the present invention, and the slot machine 1C is equivalent to the gaming machine. The slot machine 1C is provided with variable display means which variably displays a plurality of symbols as is explained with the slot machine 1A of the previously described embodiment 1. Further, the machine is able to conduct a slot game according to variable display of the plurality of symbols by using variable display means in the base game mode and constituted in such a way that it shifts to the special game mode, when a predetermined shift condition is satisfied, conducting the free game (bonus game) for a predetermined number of times.

Further, similarly with the previously described slot machine 1B of the embodiment 2, the slot machine 1C may be provided with a variable display part in plural arrays (3 arrays) which displays variable display images of a plurality of symbols and constituted in such a way that a variable display image displayed at each of the variable display parts is used to conduct a variable display image game (slot game).

The shop server 20 is provided with a CPU 201, a ROM 202, a RAM 203, a communications processor 204 and a communications controller 205. The ROM 202 stores a high probability shift condition table for setting a high probability shift condition. The high probability shift condition table (refer to FIG. 18) may be the same as or similar to the previously described one and provided with an identification information field and a determined differential number field.

The CPU 201 operates while reading and writing data into the RAM 203 according to the program stored in the ROM 202. The communications controller 205 operates the communications processor 204 according to the instructions of the CPU 201, sending and receiving data to and from the slot machine 1C. Further, the CPU 201 operates as shift condition setting means and sets the high probability shift condition (for example, the determined differential number is 2000) on the basis of the figure ID sent from each of the slot machines 1C, allowing the slot machine 1C to send data on the high probability shift condition (data on the third shift condition) from the communications processor 204. As explained so far, the communications processor 204 is to receive game related information (for example, figure ID) from the slot machine 1C and send predetermined data (for example, data on the high probability shift condition) to the slot machine 1C, and equivalent to the communications processing means of the gaming server of the present invention.

The slot machine 1C is substantially similar in constitution to the slot machine 1A but different from the previously described slot machine 1A in that it has a communications controller 75 and a communications processor 76. Therefore, the same symbols are used in the same constitutions to omit overlapping explanation. The communications controller 75 and the communications processor 76 are connected via an I/O port 39 to the CPU 32. The communications controller 75 operates the communications processor 76, following the instructions of the CPU 201, thereby sending and receiving data to and from the shop server 20. The communications processor 76 corresponds to the communications processing means of the gaming machine of the present invention. Further, similarly with the previously described slot machine 1A, the slot machine 1C is provided with a CPU 32, a figure installation unit 19, an IC chip reader/writer 19C, a figure detection sensor (not illustrated) and others. The CPU 32 operates as shift determination means, shift means, reading determination means, differential number computing means, medium setting means and calculation means. The IC chip reader/writer 19C corresponds to the reading means.

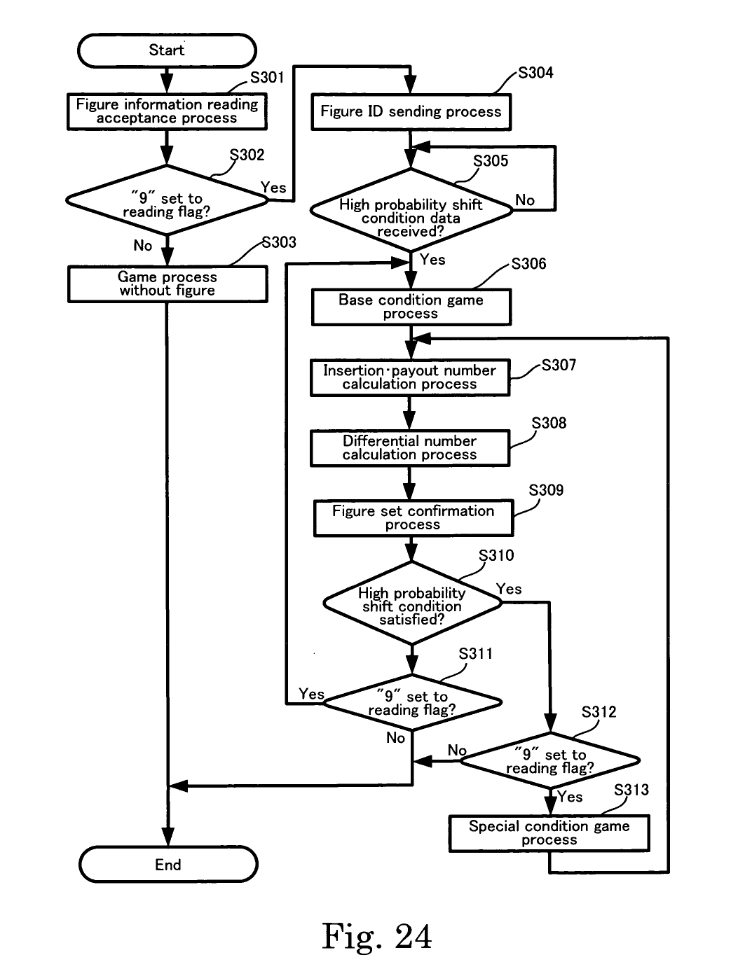

Operational description of the above-constituted gaming system 100 will be explained by referring to the flow chart shown in FIG. 24, with an emphasis given to the operation of the slot machine 1C. FIG. 24 is a flow chart showing operational procedures of the slot machine 1C in a main process from start to completion of the game. Of several slot machines 1C installed in a gaming shop, one unit is exemplified for explanation. Further, in the following explanation, where the operational description is the same as that in each process of the previously described slot machine 1A, the same process names are used to omit a detailed explanation. In FIG. 24, steps are abbreviated as “S.”

In the gaming system 100, the CPU 32 of the slot machine 1C operates as game progress control means of the present invention, thereby controlling the progress of a game. Then, as shown in FIG. 24, when a main process is started, prior to start of the game, the CPU 32 conducts a figure information reading acceptance process in the step 301, proceeding to the step 302. In the step 302, the CPU 32 operates as reading determination means and conducts a figure-absent game process (step 303) where “9” is not set to a reading flag, or proceeding to the step 304 where it is set. Where it proceeds to the step 303 to complete the figure-absent game process, the main process is also completed.

On the other hand, when it proceeds to the step 304, a figure ID sending process is conducted. When the figure ID sending process is started, the CPU 32 instructs the communications controller 75 to send the figure ID stored in the RAM 33 to the shop server 20 from the communications processor 76. In the shop server 20, on receipt of the figure ID, the CPU 201 operates as shift condition setting means to set the received identification information of the figure ID in a search key and obtain the determined differential number by referring to the high probability shift condition table stored in the ROM 202, thereby setting the number as the high probability shift condition. Then, the high probability shift condition data (data on the third shift condition) with regard to the thus obtained determined differential number are sent by the communications processor 204 to the gaming machine 1C (the gaming machine 1C which has sent the figure ID).

The slot machine 1C waits until the high probability shift condition data is received in the step 305, and the CPU 32 stores the high probability shift condition data in the RAM 33 on receipt of the high probability shift condition data.

As the program in the slot machine 1C proceeds to subsequent steps 306, 307, 308 and 309, the base condition game process, an insertion-payout number calculation process, a differential number calculation process and a figure set confirmation process are conducted. In the step 310, a determination is made for whether or not a high probability shift condition is satisfied on the basis of the high probability shift condition data. In this instance, as it is determined that the high probability shift condition is not satisfied, the program in the slot machine 1C proceeds to the step 311 and determines whether or not “9” is set to the reading flag. As it is determined that it is set thereon, it proceeds to the step 306 where the base condition game process is conducted. When determined that it is not set, the main process is completed.

On the other hand, as it is determined in the step 310 that the high probability shift condition is satisfied, the program in the slot machine 1C proceeds to the step 312 and determines whether or not “9” is set to the reading flag. If it is not set therein, the main process is completed, whereas if it is set, it proceeds to the step 313 and the special condition game process is conducted.

On completion of the special condition game process, it proceeds to the step 307 where the insertion-payout number calculation process is conducted. As long as “9” is set to the reading flag and the high probability shift condition is satisfied, the special condition game process is conducted repeatedly.

The gaming system 100 of the present embodiment also has the same actions and effects as the previously described slot machines 1A and 1B, giving newness and novelty associated with a change in the shift conditions to the player who anticipates shift from the base game to the bonus game (shift from the base game mode to the special game mode), thereby motivating the player to play the game and also making it possible to give an incentive to play the game repeatedly.

An explanation has been made so far for the gaming machine and the gaming system of the present invention by referring to individual embodiments. However, the present invention is not limited to the above-described embodiments. To be more specific, the number of reels is not limited to three, and, for example, five reels or nine reels may be available. In addition to the liquid crystal display units 41 and 101, the present invention is applicable to the gaming machine which installs another unit of displaying images (for example, display unit in which an organic EL is used). Further, in the above-described embodiments, the slot machine is used as an example of gaming machine for explanation. However, the present invention is also applicable to a card gaming machine in which a card game is played by displaying an image of playing cards or a mah-jong game machine in which a mah-jong game is played.

In addition, in the above-described embodiments, figure ID for identifying each figure is used as an example of the game related information for explanation. It is not limited to the figure ID, but it may include, for example, a period of time that the game article has been used for playing the game (the period from when the game related information is read by reading means to when it becomes non-readable), play history information such as number of times of playing the game where the game article is used to play the game, and direct information for determining specific conditions (for example, determined differential number). Then, in particular, the play history information is to be renewed by the gaming machine during the game or after completion of the game.

Further, setting of the high probability shift condition (the third shift condition) is not limited to that shown in the above-described embodiments. For example, it is acceptable that the determined differential number is obtained by lottery on the basis of the figure ID and others, and the thus obtained determined differential number is set as the high probability shift condition (third shift condition).

In addition, medium information in the present invention is not limited to credits corresponding to the number of inserted coins. For example, money information and credits which are stored in medium information storing means such as a prepaid card and magnetic card may be applicable. In this instance, the medium information storing means is inserted into the gaming machine and certain medium information stored in the medium information storing means is medium information corresponding to the number of inserted game media.

Further, the game article is not limited to the figure, but may include a card and a cassette. A mode of storing the game related information into the game article is not limited to a non-contact type data-readable IC chip, but may include contact-type data storing means. It is also acceptable that a sticker in which a bar code or two-dimensional code is printed is attached, without providing data storing means such as memory, and an information display part having the information storing function by a direct printing or marking onto a game article may be provided so that the game article can store the game related information. The two-dimensional code is also called a two-dimensional bar code, and for example, QR code (registered trade mark of Denso Wave Incorporated) is available. This two-dimensional code contains a great volume of information such that several dozen to several hundred times greater volume of data may be encoded than in the case of the bar code. When this type of information display part is provided, a bar code reader is installed as reading means in place of the previously described IC chip reader/writer.

In the above embodiment, there may be provided a gaming machine and a gaming system in which the player is provided with an incentive to play the game repeatedly without lowering a sense of anticipation that the game mode would shift to a special game mode.

For example, there is provided a gaming machine comprising: shift determination means for determining whether or not a game mode is shifted from a base game mode to a special game mode and shift means for shifting the game mode from a base game mode to a special game mode on the basis of the determination result made by the shift determination means. The gaming machine is further provided with reading means for reading the game related information from a game article which stores the game related information including identification information for discriminating oneself from others, play history information and other information of the game, and reading determination means for determining whether or not the game related information is readable by the reading means. Here, the shift determination means conducts a shift determination by referring to a first shift condition for conducting the shift determination when the reading determination means determines that the game related information is not readable. The shift determination, however, conducts the shift determination by referring to a second shift condition which provides higher probability of the shift to the special game mode than the first shift condition when the reading determination means determines that the game related information is readable.

In this gaming machine, the shift determination from the base game mode to the special game mode is conducted by referring to the first shift condition when the game related information stored in the game article is not readable, and made by referring to the second shift condition provides higher probability of the shift to the special game mode than the first shift condition when the game related information is readable.

The above-described gaming machine may be additionally provided with shift condition setting means for setting a third shift condition, by which the shift determination means makes the shift determination under the second shift condition. The shift condition setting means utilizes the game related information read by the reading means. The shift determination means may make the shift determination under the second shift condition when the reading determination means determines that the game related information is readable and also when the third shift condition is met.

In this gaming machine, since the third shift condition is set by utilizing the game related information stored in the game article, the condition is to vary depending on the game article, from which the information is read.

The above-described gaming machine is further provided with an insertion part for inserting a game medium, a payout part for paying out the game medium, and differential number calculating means for calculating a difference between the number of game media inserted from the insertion part and the number of game media paid out from the payout part, wherein, for establishment of a shift condition, a third shift condition may be established on the basis of a difference in the number obtained by the differential number calculating means.

Here, the insertion part may comprise an insertion opening including an insertion slot. The payout part may comprise a payout opening.

Further, the gaming machine is provided with medium setting means for establishing an initial game by using the medium information corresponding to the number of game media that have been already inserted, calculation means for calculating the number of used media showing the number of game media used by the medium setting means, a payout part for paying out a game medium and differential number calculating means for calculating a difference between the number of used media calculated by the calculation means and the number of game media paid out from the payout part. As to the shift condition, the third shift condition may be set on the basis of the difference in the numbers obtained by the differential number calculating means.

In the thus constituted gaming machine, since the third shift condition is set on the basis of a difference in the numbers between the number of game media inserted or used and the number of game media paid out, the condition is to vary although game media are the same.

Further, according to the present invention, there is provided a gaming system comprising: a gaming machine provided with shift determination means for determining whether or not a game mode is shifted from a base game mode to a special game mode; and shift means for shifting the game mode from the base game mode to the special game mode on the basis of the determination result made by the shift determination means, and a gaming server connected to the gaming machine. The gaming machine is further provided with reading means for reading the game related information from a game article which stores the game related information including identification information for discriminating oneself from others, play history information and other information of the game, reading determination means for determining whether or not the game related information is readable by the reading means, and communication processing means for sending, to the gaming server, data of the game related information read by the reading means and receiving the data from the gaming server. The shift determination means makes a shift determination by referring to a first shift condition when the reading determination means determines that the game related information is not readable. The shift determination means, on the other hand, makes the shift determination by referring to a second shift condition which provides higher probability of the shift to the special game mode than the first shift condition, when the reading determination means determines that the game related information is readable. The gaming server being provided with a communication processor which receives the game related information from the gaming machine and also sends predetermined data to the gaming machine; and shift condition setting means for setting a third shift condition, by which the shift determination means makes the shift determination according to the second shift condition, on the basis of the game related information sent from the gaming machine. The communication processor of the gaming server sends, to the gaming machine, data of the third shift condition set by the shift condition setting means, and the shift determination means of the gaming machine makes the above-described shift determination by referring to the second shift condition when the third shift condition based on the data sent from the gaming server is met.

In this gaming system, the game related information stored in the game article is read by the reading means of the gaming machine and sent to the gaming server. The third shift condition corresponding to the game related information is sent by the gaming server to the gaming machine. The shift determination means is able to make a shift determination by referring to the second shift condition if the third condition is satisfied.

What is claimed is:

1. A gaming machine in which a game including a base game mode and a special game mode comprising:
a display device for displaying game contents; and
a reading device for reading game related information including identification information and play history information from a game article having stored the game related information,
wherein in the game the base game mode can be shifted to the special game mode under a predetermined condition;
wherein the predetermined condition comprises a first shift condition upon determining that the game related information is in an unreadable condition from the game article;
wherein the predetermined condition comprises a second shift condition upon determining that the game related information from the game article is in a readable condition; and
wherein it is more likely that the base game mode is shifted to the special game mode under the second shift condition than under the first shift condition.

2. The gaming machine according to claim 1,
wherein a third shift condition is set based on the game related information having been read by the reading device; and
wherein the determination under the second shift condition is contingent on the third shift condition.

3. The gaming machine according to claim 1, further comprising:
an insertion opening through which game media are inserted to start the game;
a payout opening from which the game media are paid out based on a result of the game, and
an operation device for playing the game;
wherein the third shift condition is set based on a difference between a number of game media having been inserted and a number of game media having been paid out.

4. The gaming machine according to claim 2, further comprising:
an insertion opening through which game media are inserted to start the game;
a payout opening from which the game media are paid out based on a result of the game, and
an operation device for playing the game;
wherein the third shift condition is set based on a difference between a number of game media having been inserted and a number of game media having been paid out.

5. The gaming machine according to claim 1,
wherein the game related information is in a readable condition when the game article is placed on the reading device;
wherein the game related information is in an unreadable condition when the game article is removed from the reading device; and
wherein the game article is formed to be placed on or removed from the reading device while the game is being played.

6. The gaming machine according to claim 2,
wherein the game related information is in a readable condition when the game article is placed on the reading device;
wherein the game related information is in an unreadable condition when the game article is removed from the reading device; and
wherein the game article is formed to be placed on or removed from the reading device while the game is being played.

7. The gaming machine according to claim 3,
wherein the game related information is in a readable condition when the game article is placed on the reading device;
wherein the game related information is in an unreadable condition when the game article is removed from the reading device; and
wherein the game article is formed to be placed on or removed from the reading device while the game is being played.

8. A gaming system in which a game including a base game mode and a special game mode is performed, the gaming system comprising: a gaming machine; a gaming server; and a communication line between the gaming machine and the gaming server,
wherein the gaming machine comprises:
a reading device for reading game related information including identification information and play history information from a game article having stored the game related information; and
a machine communication device for communicating with the server, and
wherein the gaming server comprises:
a server communication device for communicating with the gaming machine; and
a processor which can process information sent from the gaming machine,
wherein in the game the base game mode can be shifted to the special game mode under a predetermined condition;
wherein the predetermined condition comprises a first shift condition upon determining that the game related information is in an unreadable condition from the game article;
wherein the predetermined condition comprises a second shift condition upon determining that the game related information is in a readable condition from the game article;
wherein it is more likely that the base game mode is shifted to the special game mode under the second shift condition than under the first shift condition;
wherein the game related information having been read by the reading device is sent to the gaming server by the machine communication device;
wherein a third shift condition is set based on the game related information having been sent by the machine communication device;
wherein the third shift condition is sent to the gaming machine by the server communication device; and
wherein the determination under the second shift condition is contingent on the third shift condition.

9. The gaming system according to claim 8,
wherein the third shift condition is set based on a difference between a number of game media having been inserted and a number of game media having been paid out.
